(19) United States
(12) Patent Application Publication
(10) Pub. No.: US 2024/0315243 A1
(43) Pub. Date: Sep. 26, 2024

(54) A COMBINATION OF FLUBENDIAMIDE AND SEAWEED EXTRACT

(71) Applicant: PI INDUSTRIES LTD., Udaipur -Rajasthan (IN)

(72) Inventors: Ashim Kumar DUTTA, Maharashtra (IN); Vishwanath GADE, Maharashtra (IN); Harshal Bhika SONAR, Maharashtra (IN)

(73) Assignee: PI INDUSTRIES LTD., Udaipur-Rajasthan (IN)

(21) Appl. No.: 18/572,818

(22) PCT Filed: Jun. 23, 2022
(86) PCT No.: PCT/IB2022/055812

§ 371 Date: Dec. 21, 2023

(30) Foreign Application Priority Data
Jun. 24, 2021 (IN) 202111028384

(51) Int. Cl. A01N 41/10; A01N 65/03; A01P 7/02; A01P 7/04

(52) U.S. Cl. CPC A01N 41/10; A01N 65/03; A01P 7/02; A01P 7/04

(57) ABSTRACT

The present invention discloses a combination of flubendiamide and at least one seaweed extract. The present invention also discloses to methods and compositions for the effective control of unwanted pests and mites and/or unwanted acarids. Further, the present invention discloses a method for stimulating and promoting growth of a plant and to increase yield and quality the crop.

### FIELD OF THE INVENTION

The present invention relates to a combination comprising flubendiamide and at least one seaweed extract. More particularly, the present invention relates to a combination comprising flubendiamide and at least one seaweed extract for the effective control of unwanted pests, such as insects and/or unwanted acarids. The present invention also relates a method for stimulating and promoting growth of a plant and for increasing the yield and quality of the crop.

### BACKGROUND OF THE INVENTION

Insects and plant pests cause millions of dollar's worth of damages annually on agricultural products. Furthermore, pests can have an adverse and damaging impact on agricultural production by affecting crop production. Also, pests have a detrimental effect on the environment and human health. Thus, there is a need for new techniques and compositions to combat such species of pests and mites.

Diamides insecticides are a relatively new group of insecticides and include insecticides such as flubendiamide. Flubendiamide is an organofluorine insecticide and has a role as a ryanodine receptor modulator. Flubendiamide was developed by Nihon Nohyaku Co. Ltd., and first disclosed in U.S. Pat. No. 6,603,044. Flubendiamide is chemically known as 3-iodo-N′-(2-mesyl-1,1-dimethylethyl)-N-{4-[1,2,2,2-tetrafluoro-1-(trifluoromethyl)ethyl]-o-tolyl}phthalamide and having chemical structure as below:

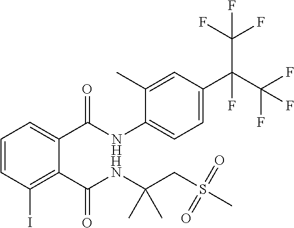 [SMILES: Cc1cc(C(F)(C(F)(F)F)C(F)(F)F)ccc1NC(=O)c1cccc(I)c1C(=O)NC(C)(C)CS(C)(=O)=O]

The insecticidal and acaricidal action of flubendiamide and its suitability as a pest control agent have been known for a long time and were described for the first time in EP1006107.

Beneficial species are particularly suitable for stimulating and promoting growth of a plant and for increasing the yield and quality of the crop. The use of beneficial species has the advantage that no resistencies are developed and that there are no waiting times for cultivation and care measures and for harvesting. Moreover, by employing beneficial species, the user is not exposed to crop protection agents.

Seaweed extracts such as Ascophyllum nodosum, Sargassum spp., Fucus spp., Fucus vesiculosus, Laminaria spp., Laminaria digitata, Laminaria hyperborea, Laminaria saccharina, Eklonia spp., Turbinaria spp., and their mixtures are used for agricultural use and are recognized worldwide as an excellent natural fertilizer and source of organic matter.

BIOVITA is based on the seaweed Ascophyllum nodosum, the finest marine plant available for agricultural use and is recognized worldwide as an excellent natural fertilizer, biostimulating activity and source of organic matter. Ascophyllum nodosum is a large, common cold water seaweed or brown alga (Phaeophyceae) in the family Fucaceae, being the only species in the genus Ascophyllum. It is seaweed that only grows in the northern Atlantic Ocean, also known in localities as feamainn bhuí, rockweed, Norwegian kelp, knotted kelp, knotted wrack or egg wrack.

BIOVITA application enables plants to receive direct benefits from the naturally balanced nutrients and plant growth substances available in the seaweed extract. BIOVITA provides over 60 naturally occurring major and minor nutrients and plant development substances comprising of enzymes, proteins, cytokinins, amino acids, vitamins, gibberellins, auxins, betains etc. in organic form.

BIOVITA provides all constituents in balanced form for healthier plant growth. BIOVITA contributes to greater microbial activity when applied to soil and thus increasing the nutrient availability to plants.

BIOVITA is an ideal organic product for better growth and productivity, which can be used on all types of plants, whether indoor, outdoor, garden, nursery, lawns, turf, agriculture or plantation crops.

It is also known that the activity of flubendiamide can be increased by combining it with other chemicals such as, for example, insecticides, fungicides or beneficial species.

EP1380209 discloses a composition for noxious organisms-controlling agent having a synergistic effect, which comprises, one or more compounds selected from the phthalamide derivatives represented by general formula (I) and one or more compounds selected from the compounds having insecticidal, acaricidal or nematocidal activity.

WO2004034786 discloses a novel insecticidally and acaricidally active compound combinations of flubendiamide and one or more compounds selected from the group consisting of triflumuron, flufenoxuron, methoxyfenozide, tebufenozide, thiacloprid, thiamethoxam, dinotefuran, clothianidin, deltamethrin, ethiprole, fipronil, indoxacarb, emamectin-benzoate, abamectin, and spinosad.

US20100310518 discloses a composition comprising flubendiamide and at least one beneficial species selected from the group consisting of predatory mites, nematodes, fungi, bacteria, virus strains, Araneae, Acari, Dermaptera, Hymenoptera, Coleoptera, Neuroptera, Thysanoptera, Heteroptera, Diptera, Hemiptera, Dermaptera Parasitiformes, and Plannipennia.

US20170311606 discloses the use of synergistic amounts of Bacillus thuringiensis subsp. kurstaki and flubendiamide for the control of Beet armyworm, Soybean looper, Corn earworm, and Cabbage looper.

However, there is no such effective composition available that decreases the chances of resistance and improves the spectrum of disease and pest control. Therefore, there is a need for composition that allows effective controlling of unwanted pests with good biostimulant activity and has a lower dosage. Further, the compositions are meant to be applied at effective dose thus decreasing the cost of farmers. It has been surprisingly found that, as a solution to the above mentioned problems, a combination of the present invention provides an effective control of unwanted insect pests and mites and/or unwanted acarids and also provides direct benefits from the naturally balanced nutrients and plant growth substances available in the seaweed extract. Further, the present invention provides a combination which provides effective control along with good biostimulant activity at a lower application dosage.

### SUMMARY OF THE INVENTION

Accordingly, the present invention provides a combination comprising:
a) flubendiamide or acceptable salt(s) thereof; and
b) at least one seaweed extract.

In one embodiment, the present invention provides a synergistic combination comprising:
a) flubendiamide or acceptable salt(s) thereof;
b) at least one seaweed extract, and
c) optionally, at least one additional active selected from insecticides, acaricides, nematicides, fungicides, herbicides or mixtures thereof.

In another embodiment, the present invention provides a synergistic combination comprising:
a) flubendiamide or acceptable salt(s) thereof;
b) at least one seaweed extract is selected from algae obtained from species of Ascophyllum nodosum, Sargassum spp., Fucus spp., Fucus vesiculosus, Laminaria spp., Laminaria digitata, Laminaria hyperborea, Laminaria saccharina, Eklonia spp., and Turbinaria spp., and
c) optionally, at least one additional active selected from insecticides, acaricides, nematicides, fungicides, herbicides and mixtures thereof.

In yet another embodiment, the present invention provides a method of effective controlling of unwanted pests, such as insects and/or unwanted acarids, wherein said method comprises applying to the locus, a combination comprising:
a) flubendiamide or acceptable salt(s) thereof;
b) at least one seaweed extract is selected from algae obtained from species of Ascophyllum nodosum, Sargassum spp., Fucus spp., Fucus vesiculosus, Laminaria spp., Laminaria digitata, Laminaria hyperborea, Laminaria saccharina, Eklonia spp., and Turbinaria spp., and
c) optionally, at least one additional active selected from insecticides, acaricides, nematicides, fungicides, herbicides and mixtures thereof.

In still another embodiment, the present invention provides a longer residual control on unwanted insect pests and mites and/or unwanted acarids treated with a combination comprising:
a) flubendiamide or acceptable salt(s) thereof; and
b) at least one seaweed extract is selected from algae obtained from species of Ascophyllum nodosum, Sargassum spp., Fucus spp., Fucus vesiculosus, Laminaria spp., Laminaria digitata, Laminaria hyperborea, Laminaria saccharina, Eklonia spp., and Turbinaria spp., and
c) optionally, at least one additional active selected from insecticides, acaricides, nematicides, fungicides, herbicides and mixtures thereof.

In still another embodiment, the present invention provides a method for stimulating and improving crop health (phyto-tonic effect), comprising treating a plant with an effective amount of a combination comprising:
a) flubendiamide or acceptable salt(s) thereof; and
b) at least one seaweed extract is selected from algae obtained from species of Ascophyllum nodosum, Sargassum spp., Fucus spp., Fucus vesiculosus, Laminaria spp., Laminaria digitata, Laminaria hyperborea, Laminaria saccharina, Eklonia spp., and Turbinaria spp., and
c) optionally, at least one additional active selected from insecticides, acaricides, nematicides, fungicides, herbicides and mixtures thereof.

In one embodiment, the present invention provides a composition comprising:
a) flubendiamide or acceptable salt(s) thereof;
b) at least one seaweed extract, and optionally, at least one additional active selected from insecticides, acaricides, nematicides, fungicides, herbicides and mixtures thereof; and
c) agriculturally acceptable carrier(s).

In another embodiment, the present invention provides a composition comprising:
a) flubendiamide or acceptable salt(s) thereof;
b) at least one seaweed extract is selected from algae obtained from species of Ascophyllum nodosum, Sargassum spp., Fucus spp., Fucus vesiculosus, Laminaria spp., Laminaria digitata, Laminaria hyperborea, Laminaria saccharina, Eklonia spp., and Turbinaria spp., and
c) optionally, at least one additional active selected from insecticides, acaricides, nematicides, fungicides, herbicides and mixtures thereof; and
d) agriculturally acceptable carrier(s).

### DETAILED DESCRIPTION OF THE INVENTION

The above embodiment and other objectives will become more apparent in view of the description given below:

### Abbreviations

| | |
|---|---|
| AE: Aerosol | SG: Water soluble granule |
| CS: Capsule suspension | SP: Water soluble powder |
| DP: Dustable powder | SU: Ultra-low volume (ULV) suspension |
| EC: Emulsifiable concentrate | ME: Micro-emulsion |
| EG: Emulsifiable granule | OD: Oil dispersion |
| EW: Oil-in water emulsion | UL: Ultra-low volume liquid |
| e.g.: Example | WDG: Water dispersible granule |
| GR: Granule | WP: Wettable powder |
| SC: Suspension concentrate | WT: Water dispersible tablet |
| SE: Suspo-emulsion | |

### Definitions

The foregoing definitions provided herein for the terminologies used in the present disclosure are for illustrative purpose only and in no manner limit, the scope of the present invention disclosed in the present disclosure.

It will be understood that the terminology used herein is for the purpose of describing embodiments only, and is not intended to be limiting. As used in this specification, the singular forms “a”, “an” and “the” include plural referents unless the context clearly dictates otherwise. Thus, for example, the reference to “a surfactant” includes one or more of such surfactants.

Unless defined otherwise, all technical and scientific terms used herein have the same meaning as commonly understood by one ordinary skilled in the art to which the invention pertains. Although other methods and materials similar, or equivalent, to those described herein can be used in the practice of the present invention, the preferred materials and methods are described herein.

As used herein, the terms “comprises”, “comprising”, “includes”, “including”, or any other variation thereof, are intended to cover a non-exclusive inclusion, subject to any limitation explicitly indicated. For example, a composition or a method that comprises a list of elements is not necessarily limited to only those elements but may include other elements not expressly listed or inherent to such composition, or method.

As used herein, the term “agrochemically acceptable salts” are typically acid addition salts of inorganic or organic acids, preferably of hydrochloric acid, hydrobromic acid, sulfuric acid, nitric acid, perchloric acid, phosphoric acid, formic acid, acetic acid, trifluoroacetic acid, oxalic acid, malonic acid, toluenesulfonic acid or benzoic acid.

As used herein, the term “composition” or “formulation” can be used interchangeably, unless stated otherwise, is meant to encompass, and are not limited to, compositions or formulations containing the combination of flubendiamide or acceptable salt(s) thereof; and at least one seaweed extract, and optionally, addition of one or more insecticides, acaricides, nematicides, fungicides, herbicides and combination thereof.

As used herein, the term “additive(s)” or “auxiliary agent(s)” or “agriculturally acceptable carrier(s)” or “agriculturally acceptable additives” can be used interchangeably and refers to inert substances which are commonly used solid carrier(s), liquid carrier(s), gaseous carrier(s), surfactant(s), binder(s), disintegrating agent(s), antioxidant(s), osmotic agent(s), wetting agent(s), pH adjuster(s), thickener(s), preservative(s), filler(s), diluent(s), emulsifier(s), anti-caking agent(s), anti-freezing agent(s), defoaming agent(s), viscosifying agent(s), extender(s), buffering agent(s), solubilizer(s), chelating agent(s), stabilizer(s), coloring agent(s) and mixture thereof, to provide stability or to increase the activity profile of the composition or formulation with or without having agrochemical activity or direct effect on the unwanted insect pests and mites and/or unwanted acarids.

As used herein, the term “surfactant(s)” means a compound that, when dissolved in a liquid, reduces the surface tension of the liquid, which reduces the interfacial tension between two liquids or which reduces surface tension between a liquid and a solid.

As used herein, the term “stabilizer(s)” refers to a substance capable of imparting resistance against physical or chemical deterioration or deformulation.

As used herein, the term “defoaming agent(s)” refers to a chemical additive that reduces and hinders the formation of foam in the industrial process liquids, semi-solids, or solids. The terms defoaming agent and anti-foaming agent can be used interchangeably.

As used herein, the term “thickener(s)” refers to a polymeric material, which at a low concentration increases the viscosity of an aqueous solution and helps to stabilize the composition.

Unless otherwise specified, % refers to % weight; and % weight refers to % of the weight of the respective component with respect to the total weight of the composition.

As used herein, the term “locus” means a plant, plant parts, plant propagation material (preferably seed), soil, area, material or environment in which a pest is growing or may grow.

As used herein, the term “plant parts” are understood to mean all above-ground and below-ground parts and organs of plants, such as shoot, leaf, flower and root, examples including leaves, needles, stems, stalks, flowers, fruit-bodies, fruits and seeds, and also roots, tubers and rhizomes. The plant parts also include harvested plants and vegetative and generative propagation material, for example seedlings, tubers, rhizomes, cuttings and seeds.

As used herein, the term “effective amount” means the amount of the active substances in the compositions to achieve an observable effect on growth, including the effects of necrosis, death, retardation, prevention, and removal, destruction, or otherwise diminishing the occurrence and activity of the target organism. The effective amount can vary for the various compositions used in the present invention. An effective amount of the compositions will also vary according to the prevailing conditions such as desired pesticidal effect and duration, weather, target species, locus, mode of application, and the like.

As used herein, the term “flubendiamide” encompasses flubendiamide or its agrochemically acceptable salt(s), derivative(s) or any other modified form of flubendiamide.

As used herein, the term “Beneficial species” or “Seaweed extract” encompasses Ascophyllum nodosum, Sargassum spp., Fucus spp., Fucus vesiculosus, Laminaria spp., Laminaria digitata, Laminaria hyperborea, Laminaria saccharina, Eklonia spp., and Turbinaria spp., and mixture thereof.

As used herein, the term “BIOVITA” encompasses Ascophyllum nodosum.

In view of the above, the present invention provides a combination comprising:
a) flubendiamide or acceptable salt(s) thereof; and
b) at least one seaweed extract.

In one embodiment, the present invention provides a synergistic combination comprising:
a) flubendiamide or acceptable salt(s) thereof; and
b) at least one seaweed extract, and
c) optionally, at least one additional active selected from insecticides, acaricides, nematicides, fungicides, herbicides and mixtures thereof.

In a preferred embodiment, the seaweed extract is selected from algae obtained from species of Ascophyllum nodosum, Sargassum spp., Fucus spp., Fucus vesiculosus, Laminaria spp., Laminaria digitata, Laminaria hyperborea, Laminaria saccharina, Eklonia spp., and Turbinaria spp., and mixtures thereof.

In another preferred embodiment, the present invention provides a synergistic combination comprising: a) flubendiamide or acceptable salt(s) thereof; and b) seaweed extract is Ascophyllum nodosum.

In yet another preferred embodiment, the present invention provides a synergistic combination comprising: a) flubendiamide or acceptable salt(s) thereof; and b) seaweed extract is Sargassum spp.

In yet another preferred embodiment, the present invention provides a synergistic combination comprising: a) flubendiamide or acceptable salt(s) thereof; and b) seaweed extract is Fucus spp., particularly selected from, Fucus vesiculosus.

In yet another preferred embodiment, the present invention provides a synergistic combination comprising: a) flubendiamide or acceptable salt(s) thereof; and b) seaweed extract is Laminaria spp., particularly selected from, Laminaria digitata, Laminaria hyperborea, Laminaria saccharina, and mixtures thereof.

In yet another preferred embodiment, the present invention provides a synergistic combination comprising: a) flubendiamide or acceptable salt(s) thereof; and b) seaweed extract is Eklonia spp.

In yet another preferred embodiment, the present invention provides a synergistic combination comprising: a) flubendiamide or acceptable salt(s) thereof; and b) seaweed extract is Turbinaria spp.

In one embodiment, the present invention provides a composition comprising:
a) flubendiamide or acceptable salt(s) thereof;
b) at least one seaweed extract, and optionally, at least one additional active selected from insecticides, acaricides, nematicides, fungicides, herbicides and mixtures thereof; and
c) agriculturally acceptable carrier(s).

The seaweed extract is selected from algae obtained from species of Ascophyllum nodosum, Sargassum spp., Fucus spp., Fucus vesiculosus, Laminaria spp., Laminaria digitata, Laminaria hyperborea, Laminaria saccharina, Eklonia spp., and Turbinaria spp., and mixtures thereof.

The ratio of flubendiamide and seaweed extract is from 100:1 to 1:100, more preferably 50:1 to 1:50, most preferably 20:1 to 1:20.

In a preferred embodiment, the ratio of flubendiamide and Ascophyllum nodosum is from 100:1 to 1:100, more preferably 50:1 to 1:50, most preferably 20:1 to 1:20.

In another preferred embodiment, the ratio of flubendiamide and Sargassum spp. is from 100:1 to 1:100, more preferably 50:1 to 1:50, most preferably 20:1 to 1:20.

In yet another preferred embodiment, the ratio of flubendiamide and Fucus spp. is from 100:1 to 1:100, more preferably 50:1 to 1:50, most preferably 20:1 to 1:20.

In yet another preferred embodiment, the ratio of flubendiamide and Laminaria spp. is from 100:1 to 1:100, more preferably 50:1 to 1:50, most preferably 20:1 to 1:20.

In yet another preferred embodiment, the ratio of flubendiamide and Eklonia spp. is from 100:1 to 1:100, more preferably 50:1 to 1:50, most preferably 20:1 to 1:20.

In yet another preferred embodiment, the ratio of flubendiamide and Turbinaria spp. is from 100:1 to 1:100, more preferably 50:1 to 1:50, most preferably 20:1 to 1:20.

In one embodiment, a particle size of the active ingredient(s) is in the range of having range of 1 to 80 μm, more preferably 1 to 50 μm, most preferably 5 to 20 μm.

In one embodiment, the particle size of the active ingredient(s) is in the range of (d50 or d90, determined after dispersion in the water phase by laser diffraction) having range of 1 to 80 μm, more preferably 1 to 50 μm, most preferably 5 to 20 μm.

In one embodiment, the present invention provides a synergistic combination comprising:
a) flubendiamide or acceptable salt(s) thereof;
b) at least one seaweed extract; and
c) at least one insecticide.

The insecticide as used in the composition/combination of the present invention is selected from the following groups:
(I-A) acetyl cholinesterase (AChE) inhibitors,
(I-B) GABA-gated chloride channel blockers,
(I-C) sodium channel modulators,
(I-D) nicotinic acetylcholine receptor (nAChR) competitive modulators,
(I-E) nicotinic acetylcholine receptor (nAChR) allosteric modulators—site I,
(I-F) glutamate-gated chloride channel (GluCl) allosteric modulators,
(I-G) juvenile hormone mimics,
(I-H) miscellaneous non-specific (multi-site) inhibitors,
(I-I) chordotonal organ transient receptor potential (TRPV) channel modulators,
(I-J) mite growth inhibitors affecting chitin synthase 1 (CHS1),
(I-K) microbial disruptors of insect midgut membranes,
(I-L) inhibitors of mitochondrial ATP synthase,
(I-M) uncouplers of oxidative phosphorylation via disruption of the proton gradient,
(I-N) nicotinic acetylcholine receptor (nAChR) channel blockers,
(I-O) inhibitors of the chitin biosynthesis affecting CHS1,
(I-P) inhibitors of the chitin biosynthesis type 1,
(I-Q) moulting disruptors,
(I-R) ecdysone receptor agonists,
(I-S) octopamin receptor agonists,
(I-T) mitochondrial complex III electron transport inhibitors,
(I-U) mitochondrial complex I electron transport inhibitors,
(I-V) voltage-dependent sodium channel blockers,
(I-W) inhibitors of the acetyl CoA carboxylase,
(I-X) mitochondrial complex IV electron transport inhibitors,
(I-Y) mitochondrial complex II electron transport inhibitors,
(I-Z) ryanodine receptor modulators,
(I-AA) chordotonal organ modulators,
(I-BB) GABA-gated chloride channel allosteric modulators,
(I-CC) baculoviruses,
(I-DD) nicotinic acetylcholine receptor (nAChR) allosteric modulators—site II,
(I-EE) insecticidal active compound of unknown or uncertain mode of action,
(I-FF) biopesticides, and
(I-GG) biochemical pesticides with insecticidal, acaricidal, molluscidal, pheromone and/or nematicidal activity.

In preferred embodiment, the insecticide as used in the composition/combination of the present invention is selected from the following groups:
a) (I-A) acetylcholinesterase (AChE) inhibitors, selected from the class of
(I-A1) carbamates, for example, (I-A1001) alanycarb, (I-A1002) aldicarb, (I-A1003) bendiocarb, (I-A1004) benfuracarb, (I-A1005) butocarboxim, (I-A1006) butoxycarboxim, (I-A1007) carbaryl, (I-A 1008) carbofuran, (I-A1009) carbosulfan, (I-A1010) ethiofencarb, (I-A1011) fenobucarb, (I-A1012) formetanate, (I-A1013) furathiocarb, (I-A1014) isoprocarb, (I-A1015) methiocarb, (I-A1016) methomyl, (I-A1017) metolcarb, (I-A1018) oxamyl, (I-A1019) pirimicarb, (I-A1020) propoxur, (I-A1021) thiodicarb, (I-A1022) thiofanox, (I-A1023) triazamate, (I-A1024) trimethacarb, (I-A1025) 3,5-Xylyl methylcarbamate (XMC), (I-A1026) xylylcarb;
(I-A2) organophosphates, for example, (I-A2001) acephate, (I-A2002) azamethiphos, (I-A2003) azinphos-ethyl, (I-A2004) azinphosmethyl, (I-A2005) cadusafos, (I-A2006) chlorethoxyfos, (I-A2007) chlorfenvinphos, (I-A2008) chlormephos, (I-A2009) chlorpyrifos, (I-A2010) chlorpyrifos-methyl, (I-A2011) coumaphos, (I-A2012) cyanophos, (I-A2013) demeton-s-methyl, (I-A2014) diazinon, (I-A2015) dichlorvos/ddvp, (I-A2016) dicrotophos, (I-A2017) dimethoate, (I-A2018) dimethylvinphos, (I-A2019) disulfoton, (I-A2020) EPN, (I-A2021) ethion, (I-A2022) ethoprophos, (I-A2023) famphur, (I-A2024) fenamiphos, (I-A2025) fenitrothion, (I-A2026) fenthion, (I-A2027) fosthiazate, (I-A2028) heptenophos, (I-A2029) imicyafos, (I-A2030) isofenphos, (I-A2031) isopropyl o-(methoxyaminothio-phosphoryl) salicylate, (I-A2032) isoxathion, (I-A2033) malathion, (I-A2034) mecarbam, (I-A2035) methamidophos, (I-A2036) methidathion, (I-A2037) mevinphos, (I-A2038) monocrotophos, (I-A2039) naled, (I-A2040) omethoate, (I-A2041) oxydemeton-methyl, (I-A2042) parathion, (I-A2043) parathion-methyl, (I-A2044) phenthoate, (I-A2045) phorate, (I-A2046) phosalone, (I-A2047) phosmet, (I-A2048) phosphamidon, (I-A2049) phoxim, (I-A2050) pirimiphos-methyl, (I-A2051) profenofos, (I-A2052) propetamphos, (I-A2053) prothiofos, (I-A2054) pyraclofos, (I-A2055) pyridaphenthion, (I-A2056) quinalphos, (I-A2057) sulfotep, (I-A2058) tebupirimfos, (I-A2059) temephos, (I-A2060) terbufos, (I-A2061) tetrachlorvinphos, (I-A2062) thiometon, (I-A2063) triazophos, (I-A2064) trichlorfon, (I-A2065) vamidothion;
b) (I-B) GABA-gated chloride channel blockers, selected from the class of
(I-B1) cyclodiene organochlorines, for example, (I-B1001) chlordane, (I-B1002) endosulfan;
(I-B2) phenylpyrazoles (fiproles), for example, (I-B2001) ethiprole, (I-B2002) fipronil, (I-B2003) flufiprole, (I-B2004) pyrafluprole, (I-B2005) pyriprole;
c) (I-C) sodium channel modulators, selected from the class of
(I-C1) pyrethroids/pyrethrins, for example, (I-C1001) acrinathrin, (I-C1002) allethrin, (I-C1003) d-cis-trans allethrin, (I-C1004) d-trans-allethrin, (I-C1005) bifenthrin, (I-C1006) bioallethrin, (I-C1007) bioallethrin s-cyclopentenyl isomer, (I-C1008) bioresmethrin, (I-C1009) cycloprothrin, (I-C1010) cyfluthrin, (I-C1011) beta-cyfluthrin, (I-C1012) cyhalothrin, (I-C1013) lambda-cyhalothrin, (I-C1014) gamma-cyhalothrin, (I-C1015) cypermethrin, (I-C1016) alpha-cypermethrin, (I-C1017) beta-cypermethrin, (I-C1018) theta-cypermethrin, (I-C1019) zeta-cypermethrin, (I-C1020) cyphenothrin, (I-C1021) (1R)-trans-cyphenothrin, (I-C1022) deltamethrin, (I-C1023) empenthrin (EZ)-(1R)-isomers], (I-C1024) esfenvalerate, (I-C1025) etofenprox, (I-C1026) fenpropathrin, (I-C1027) fenvalerate, (I-C1028) flucythrinate, (I-C1029) flumethrin, (I-C1030) tau-fluvalinate, (I-C1031) halfenprox, (I-C1032) imiprothrin, (I-C1033) meperfluthrin, (I-C1034) metofluthrin, (I-C1035) momfluorothrin, (I-C1036) kadethrin, (I-C1037) permethrin, (I-C1038) phenothrin [(1R)-trans-isomer], (I-C1039) prallethrin, (I-C1040) profluthrin, (I-C1041) pyrethrins (pyrethrum), (I-C1042) resmethrin, (I-C1043) silafluofen, (I-C1044) tefluthrin, (I-C1045) tetramethylfluthrin, (I-C1046) tetramethrin, (I-C1047) tetramethrin [(1R)-isomers], (I-C1048) tralomethrin, (I-C1049) transfluthrin;
(I-C2) organochlorine, for example, (I-C2001) DDT, (I-C2002) methoxychlor;
d) (I-D) nicotinic acetylcholine receptor (nAChR) competitive modulators, selected from the class of
(I-D1) neonicotinoids, for example, (I-D1001) acetamiprid, (I-D1002) clothianidin, (I-D1003) dinotefuran, (I-D1004) imidacloprid, (I-D1005) nitenpyram, (I-D1006) thiacloprid, (I-D1007) thiamethoxam;
(I-D2001) nicotine;
(I-D3) sulfoximines, for example, (I-D3001) sulfoxaflor;
(I-D4) butenolides, for example, (I-D4001) flupyradifurone;
(I-D5) mesoionics, for example, (I-D5001) triflumezopyrim, (I-D5002) dichloromezotiaze;
(I-D6) pyridylidenes, for example, (I-D6001) flupyrimin;
e) (I-E) nicotinic acetylcholine receptor (nAChR) allosteric modulators—Site I, selected from the class of
(I-E1) spinosyns, for example, (I-E1001) spinetoram, (I-E1002) spinosad;
f) (I-F) glutamate-gated chloride channel (GluCl) allosteric modulators, selected from the class of
(I-F1) avermectins/milbemycins, for example, (I-F1001) abamectin, (I-F1002) emamectin benzoate,
(I-F1003) lepimectin, (I-F1004) milbemectin;
g) (I-G) juvenile hormone mimics, selected from the class of
(I-G1) juvenile hormone analogues, for example, (I-G1001) hydroprene, (I-G1002) kinoprene, (I-G1003) methoprene;
(I-G2001) fenoxycarb;
(I-G3001) pyriproxyfen;
h) (I-H) miscellaneous non-specific (multi-site) inhibitors, selected from the class of
(I-H1) alkyl halides, for example, (I-H1001) methyl bromide, (I-H1002) other alkyl halides;
(I-H2001) chloropicrin;
(I-H3) fluorides, for example, (I-H3001) cryolite (sodium aluminium fluoride), (I-H3002) sulfuryl fluoride;
(I-H4) borates, for example, (I-H4001) borax, (I-H4002) boric acid, (I-H4003) disodium octaborate,
(I-H4004) sodium borate, (I-H4005) sodium metaborate;
(I-H5001) tartar emetic;
(I-H6) methyl isothiocyanate generators, for example, (I-H6001) dazomet, (I-H6002) metam;
i) (I-I) chordotonal organ TRPV channel modulators, selected from the class of
(I-I1) pyridine azomethine derivatives, for example, (I-I1001) pymetrozine, (I-I1002) pyrifluquinazon;
(I-I2001) afidopyropen;
j) (I-J) mite growth inhibitors affecting CHS1, selected from the class of
(I-J1) clofentezine, Diflovidazin, Hexythiazox, for example, (I-J1001) clofentezine, (I-J1002) hexythiazox, (I-J1003) diflovidazin;
(I-J2001) etoxazole;
k) (I-K) microbial disruptors of insect midgut membranes, selected from the class of
(I-K1) Bacillus thuringiensis and the insecticidal proteins they produce, for example, (I-K1001) Bacillus thuringiensis, (I-K1002) Bacillus thuringiensis var. israelensis, (I-K1003) Bacillus thuringiensis var. aizawai, (I-K1004) Bacillus thuringiensis var. kurstaki, (I-K1005) Bacillus thuringiensis var. tenebrionis;
(I-K2001) Bacillus sphaericus;
l) (I-L) inhibitors of mitochondrial ATP synthase, selected from the class of
(I-L1001) diafenthiuron;
(I-L2) organotin miticides, for example, (I-L2001) azocyclotin, (I-L2002) cyhexatin, (I-L2003) fenbutatin oxide;
(I-L3001) propargite;
(I-L4001) tetradifon;
m) (I-M) uncouplers of oxidative phosphorylation via disruption of the proton gradient, selected from the class of
(I-M1) pyrroles, for example, (I-M1001) chlorfenapyr;
(I-M2) dinitrophenols, for example, (I-M2001) DNOC;
(I-M3001) sulfluramid;
n) (I-N) nicotinic acetylcholine receptor (nAChR) channel blockers, selected from the class of
(I-N1) nereistoxin analogues, for example, (I-N1001) bensultap, (I-N1002) cartap hydrochloride, (I-N1003) thiocyclam, (I-N1004) thiosultap-sodium;
o) (I-O) inhibitors of the chitin biosynthesis affecting CHS1, selected from the class of
(I-O1) benzoylureas, for example, (I-O1001) bistrifluron, (I-O1002) chlorfluazuron, (I-O1003) diflubenzuron, (I-O1004) flucycloxuron, (I-O1005) flufenoxuron, (I-O1006) hexaflumuron, (I-O1007) lufenuron, (I-O1008) novaluron, (I-O1009) noviflumuron, (I-O1010) teflubenzuron, (I-O1011) triflumuron;
p) (I-P) inhibitors of the chitin biosynthesis type 1, for example, (I-P1001) buprofezin; q) (I-Q) moulting disruptors, selected from the class of
(I-Q1) dipteran, for example, (I-Q1001) cyromazine;
r) (I-R) ccdysone receptor agonists, selected from the class of
(I-R1) diacylhydrazines, for example, (I-R1001) methoxyfenozide, (I-R1002) tebufenozide, (I-R1003) halofenozide, (I-R1004) fufenozide, (I-R1005) chromafenozide;
s) (I-S) octopamin receptor agonists, for example, (I-S1001) amitraz;
t) (I-T) mitochondrial complex III electron transport inhibitors, for example, (I-T1001) hydramethylnon; (I-T2001) acequinocyl; (I-T3001) fluacrypyrim; (I-T4001) bifenazate;
u) (I-U) mitochondrial complex I electron transport inhibitors, selected from the class of
(I-U1) METI acaricides and insecticides, for example, (I-U1001) fenazaquin, (I-U1002) fenpyroximate, (I-U1003) pyrimidifen, (I-U1004) pyridaben, (I-U1005) tebufenpyrad, (I-U1006) tolfenpyrad;
(I-U2001) rotenone;
v) (I-V) voltage-dependent sodium channel blockers, selected from the class of
(I-V1) oxadiazines, for example, (I-V1001) indoxacarb;
(I-V2) semicarbazones, for example, (I-V2001) metaflumizone;
w) (I-W) inhibitors of the acetyl CoA carboxylase, selected from the class of
(I-W1) tetronic and tetramic acid derivatives, for example, (I-W1001) spirodiclofen, (I-W1002) spiromesifen, (I-W1003) spiropidion, (I-W1004) spirotetramat;
x) (I-X) mitochondrial complex IV electron transport inhibitors, selected from the class of
(I-X1) phosphides, for example, (I-X1001) aluminium phosphide, (I-X1002) calcium phosphide, (I-X1003) phosphine, (I-X1004) zinc phosphide;
(I-X2) cyanides, for example, (I-X2001) calcium cyanide, (I-X2002) potassium cyanide, (I-X2003) sodium cyanide;
y) (I-Y) mitochondrial complex II electron transport inhibitors, selected from the class of
(I-Y1) beta-ketonitrile derivatives, for example, (I-Y1001) cyenopyrafen, (I-Y1002) cyflumetofen;
(I-Y2) carboxanilides, for example, (I-Y2001) pyflubumide;
z) (I-Z) ryanodine receptor modulators, selected from the class of
(I-Z1) diamides, for example, (I-Z1001) tetra-chlorantraniliprole, (I-Z1002) chlorantraniliprole (Rynaxypyr®), (I-Z1003) cyantraniliprole (Cyazypyr®), (I-Z1004) cyclaniliprole, (I-Z1005) tetraniliprole;
aa) (I-AA) chordotonal organ Modulators—undefined target site, for example, (I-AA1001) flonicamid;
bb) (I-BB) GABA-gated chloride channel allosteric modulators, selected from the class of
(I-BB1) meta-diamides, for example, (I-BB1001) broflanilide;
(I-BB2) isoxazolines, for example, (I-BB2001) fluxametamide, (I-BB2002) isocycloseram;
cc) (I-CC) insecticidal active compounds of unknown or uncertain mode of action, for example, (I-CC1001) acynonapyr, (I-CC1002) azadirachtin, (I-CC1003) amidoflumet, (I-CC1004) benzoximate, (I-CC1005) benzpyrimoxan, (I-CC1006) bifenazate, (I-CC1007) bromopropylate, (I-CC1008) chinomethionat, (I-CC1009) cryolite, (I-CC1010) dicofol, (I-CC1011) flufenerim, (I-CC1012) flometoquin, (I-CC1013) fluhexafon, (I-CC1014) fluensulfone, (I-CC1015) flupyradifurone, (I-CC1016) lime sulphur, (I-CC1017) mancozeb, (I-CC1018) piperonyl butoxide, (I-CC1019) pyridalyl, (I-CC1020) pyrifluquinazon, (I-CC1021) sulfoxaflor, (I-CC1022) sulphur, (I-CC1023) dimpropyridaz, (I-CC1024) tyclopyrazoflor, (I-CC1025) nicofluprole; and
dd) (I-DD) biochemical pesticides with insecticidal, acaricidal, molluscidal, pheromone and/or nematicidal activity, for example, (I-DD1001) L-carvone, (I-DD1002) citral, (I-DD1003) (E,Z)-7,9-dodecadien-1-yl acetate, (I-DD1004) ethyl formate, (I-DD1005) (E,Z)-2,4-ethyl decadienoate (pear ester), (I-DD1006) (Z,Z,E)-7,11,13-hexadecatrienal, (I-DD1007) heptyl butyrate, (I-DD1008) isopropyl myristate, (I-DD1009) lavanulyl senecioate, (I-DD1010) 2-methyl 1-butanol,
(I-DD1011) methyl eugenol, (I-DD1012) methyl jasmonate, (I-DD1013) (E,Z)-2,13-octadecadien-1-ol, (I-DD1014) (E,Z)-2,13-octadecadien-1-ol acetate, (I-DD1015) (E,Z)-3,13-octadecadien-1-ol, (I-DD1016) R-1-octen-3-ol, (I-DD1017) pentatermanone, (I-DD1018) potassium silicate, (I-DD1019) sorbitol actanoate, (I-DD1020) (E,Z,Z)-3,8,11-tetradecatrienyl acetate, (I-DD1021) (Z,E)-9,12-tetradecadien-1-yl acetate, (I-DD1022) Z-7-tetradecen-2-one, Z-9-tetradecen-1-yl acetate, (I-DD1023) Z-11-tetradecenal, (I-DD1024) Z-11-tetradecen-1-ol, (I-DD1025) Acacia negra extract, (I-DD1026) extract of grapefruit seeds and pulp, (I-DD1027) extract of Chenopodium ambrosiodae, (I-DD1028) fatty acid monoester with glycerol or propanediol, (I-DD1029) catnip oil, (I-DD1030) neem oil, (I-DD1031) quillay extract, (I-DD1032) tagetes oil.

In preferred embodiment, the insecticide as used in the composition/combination of the present invention is selected from the group consisting of
(I-A) acetylcholinesterase (AChE) inhibitors, selected from the class of
(I-A1) carbamates, for example, (I-A1001) alanycarb, (I-A1002) aldicarb, (I-A1003) bendiocarb, (I-A1004) benfuracarb, (I-A1005) butocarboxim, (I-A1006) butoxycarboxim, (I-A1007) carbaryl, (I-A 1008) carbofuran, (I-A1009) carbosulfan, (I-A1010) ethiofencarb, (I-A1011) fenobucarb, (I-A1012) formetanate, (I-A1013) furathiocarb, (I-A1014) isoprocarb, (I-A1015) methiocarb, (I-A1016) methomyl, (I-A1017) metolcarb, (I-A1018) oxamyl, (I-A1019) pirimicarb, (I-A1020) propoxur, (I-A1021) thiodicarb, (I-A1022) thiofanox, (I-A1023) triazamate, (I-A1024) trimethacarb, (I-A1025) 3,5-Xylyl methylcarbamate (XMC), (I-A1026) xylylcarb;
(I-A2) organophosphates, for example, (I-A2001) acephate, (I-A2002) azamethiphos, (I-A2003) azinphos-ethyl, (I-A2004) azinphosmethyl, (I-A2005) cadusafos, (I-A2006) chlorethoxyfos, (I-A2007) chlorfenvinphos, (I-A2008) chlormephos, (I-A2009) chlorpyrifos, (I-A2010) chlorpyrifos-methyl, (I-A2011) coumaphos, (I-A2012) cyanophos, (I-A2013) demeton-s-methyl, (I-A2014) diazinon, (I-A2015) dichlorvos/ddvp, (I-A2016) dicrotophos, (I-A2017) dimethoate, (I-A2018) dimethylvinphos, (I-A2019) disulfoton, (I-A2020) EPN, (I-A2021) ethion, (I-A2022) ethoprophos, (I-A2023) famphur, (I-A2024) fenamiphos, (I-A2025) fenitrothion, (I-A2026) fenthion, (I-A2027) fosthiazate, (I-A2028) heptenophos, (I-A2029) imicyafos, (I-A2030) isofenphos, (I-A2031) isopropyl o-(methoxyaminothio-phosphoryl) salicylate, (I-A2032) isoxathion, (I-A2033) malathion, (I-A2034) mecarbam, (I-A2035) methamidophos, (I-A2036) methidathion, (I-A2037) mevinphos, (I-A2038) monocrotophos, (I-A2039) naled, (I-A2040) omethoate, (I-A2041) oxydemeton-methyl, (I-A2042) parathion, (I-A2043) parathion-methyl, (I-A2044) phenthoate, (I-A2045) phorate, (I-A2046) phosalone, (I-A2047) phosmet, (I-A2048) phosphamidon, (I-A2049) phoxim, (I-A2050) pirimiphos-methyl, (I-A2051) profenofos, (I-A2052) propetamphos, (I-A2053) prothiofos, (I-A2054) pyraclofos, (I-A2055) pyridaphenthion, (I-A2056) quinalphos, (I-A2057) sulfotep, (I-A2058) tebupirimfos, (I-A2059) temephos, (I-A2060) terbufos, (I-A2061) tetrachlorvinphos, (I-A2062) thiometon, (I-A2063) triazophos, (I-A2064) trichlorfon, (I-A2065) vamidothion; or
(I-C) sodium channel modulators, selected from the class of
(I-C1) pyrethroids/pyrethrins, for example, (I-C1001) acrinathrin, (I-C1002) allethrin, (I-C1003) d-cis-trans allethrin, (I-C1004) d-trans-allethrin, (I-C1005) bifenthrin, (I-C1006) bioallethrin, (I-C1007) bioallethrin s-cyclopentenyl isomer, (I-C1008) bioresmethrin, (I-C1009) cycloprothrin, (I-C1010) cyfluthrin, (I-C1011) beta-cyfluthrin, (I-C1012) cyhalothrin, (I-C1013) lambda-cyhalothrin, (I-C1014) gamma-cyhalothrin, (I-C1015) cypermethrin, (I-C1016) alpha-cypermethrin, (I-C1017) beta-cypermethrin, (I-C1018) theta-cypermethrin, (I-C1019) zeta-cypermethrin, (I-C1020) cyphenothrin, (I-C1021) (1R)-trans-cyphenothrin, (I-C1022) deltamethrin, (I-C1023) empenthrin (EZ)-(1R)-isomers], (I-C1024) esfenvalerate, (I-C1025) etofenprox, (I-C1026) fenpropathrin, (I-C1027) fenvalerate, (I-C1028) flucythrinate, (I-C1029) flumethrin, (I-C1030) tau-fluvalinate, (I-C1031) halfenprox, (I-C1032) imiprothrin, (I-C1033) meperfluthrin, (I-C1034) metofluthrin, (I-C1035) momfluorothrin, (I-C1036) kadethrin, (I-C1037) permethrin, (I-C1038) phenothrin [(1R)-trans-isomer], (I-C1039) prallethrin, (I-C1040) profluthrin, (I-C1041) pyrethrins (pyrethrum), (I-C1042) resmethrin, (I-C1043) silafluofen, (I-C1044) tefluthrin, (I-C1045) tetramethylfluthrin, (I-C1046) tetramethrin, (I-C1047) tetramethrin [(1R)-isomers], (I-C1048) tralomethrin, (I-C1049) transfluthrin;
(I-C2) organochlorine, for example, (I-C2001) DDT, (I-C2002) methoxychlor;
(I-D) nicotinic acetylcholine receptor (nAChR) competitive modulators, selected from the class of
(I-D1) neonicotinoids, for example, (I-D1001) acetamiprid, (I-D1002) clothianidin, (I-D1003) dinotefuran, (I-D1004) imidacloprid, (I-D1005) nitenpyram, (I-D1006) thiacloprid, (I-D1007) thiamethoxam;
(I-D2001) nicotine;
(I-D3) sulfoximines, for example, (I-D3001) sulfoxaflor;
(I-D4) butenolides, for example, (I-D4001) flupyradifurone;
(I-D5) mesoionics, for example, (I-D5001) triflumezopyrim, (I-D5002) dichloromezotiaze;
(I-D6) pyridylidenes, for example, (I-D6001) flupyrimin;
(I-P) inhibitors of the chitin biosynthesis type 1, for example, (I-P1001) buprofezin;
(I-Z) ryanodine receptor modulators, selected from the class of
(I-Z1) diamides, for example, (I-Z1001) tetra-chlorantraniliprole, (I-Z1002) chlorantraniliprole (Rynaxypyr®), (I-Z1003) cyantraniliprole (Cyazypyr®), (I-Z1004) cyclaniliprole, (I-Z1005) tetraniliprole.

In a preferred embodiment, the present invention provides a synergistic combination comprising:
a) flubendiamide or acceptable salt(s) thereof;
b) at least one seaweed extract; and
c) profenofos or acceptable salt(s) thereof.

In another preferred embodiment, the present invention provides a synergistic combination comprising:
a) flubendiamide or acceptable salt(s) thereof;
b) at least one seaweed extract; and
c) deltamethrin or acceptable salt(s) thereof.

In yet another preferred embodiment, the present invention provides a synergistic combination comprising:
a) flubendiamide or acceptable salt(s) thereof;
b) at least one seaweed extract; and
c) thiacloprid or acceptable salt(s) thereof.

In yet another preferred embodiment, the present invention provides a synergistic combination comprising:
a) flubendiamide or acceptable salt(s) thereof;
b) at least one seaweed extract; and
c) buprofezin or acceptable salt(s) thereof.

In one embodiment, the present invention provides a synergistic combination comprising:
a) flubendiamide or acceptable salt(s) thereof;
b) at least one seaweed extract; and
c) at least one fungicide.

The fungicide as used in the combination/composition of the present invention is selected from the following groups:
(II-A) inhibitors of the sterol biosynthesis,
(II-B) inhibitors of the respiratory chain at complex I or II,
(II-C) inhibitors of the respiratory chain at complex III,
(II-D) inhibitors of the mitosis and cell division,
(II-E) compounds capable of having a multisite action,
(II-F) compounds capable of inducing a host defense,
(II-G) inhibitors of the amino acid and/or protein biosynthesis,
(II-H) inhibitors of the ATP production,
(II-I) inhibitors of the cell wall synthesis,
(II-J) inhibitors of the lipid and membrane synthesis,
(II-K) inhibitors of the melanine biosynthesis,
(II-L) inhibitors of the nucleic acid synthesis,
(II-M) inhibitors of the signal transduction,
(II-N) compounds capable of acting as uncoupler,
(II-O) other fungicides,
(II-P) HDAC inhibitors,
(II-Q) compounds capable to act as a safener, and
(II-R) biological fungicides.

The fungicide as used in the combination/composition of the present invention is selected from the following groups:
(II-A) inhibitors of the sterol biosynthesis, for example, (II-A001) cyproconazole, (II-A002) difenoconazole, (II-A003) epoxiconazole, (II-A004) fenhexamid, (II-A005) fenpropidin, (II-A006) fenpropimorph, (II-A007) fenpyrazamine, (II-A008) fluquinconazole, (II-A009) flutriafol, (II-A010) imazalil, (II-A011) imazalil sulfate, (II-A012) ipconazole, (II-A013) metconazole, (II-A014) myclobutanil, (II-A015) paclobutrazol, (II-A016) prochloraz, (II-A017) propiconazole, (II-A018) prothioconazole, (II-A019) pyrisoxazole, (II-A020) spiroxamine, (II-A021) tebuconazole, (II-A022) tetraconazole, (II-A023) triadimenol, (II-A024) tridemorph, (II-A025) triticonazole, (II-A026) mefentrifluconazole, (II-A027) ipfentrifluconazole, II-A028) terbinafine, (II-A029) buthiobate, (II-A030) pyrifenox, (II-A031) fenarimol, (II-A032) nuarimol, (II-A033) triarimol, (II-A034) triforine, (II-A035) clotrimazole, (II-A036) econazole, (II-A037) isoconazole, (II-A038) miconazole, (II-A039) oxpoconazole, (II-A040) pefurazoate, (II-A041) triflumizole, (II-A042) azaconazole, (II-A043) bitertanol, (II-A044) bromuconazole, (II-A045) diniconazole, (II-A046) diniconazole-M, (II-A047) etaconazole, (II-A048) fenbuconazole, (II-A049) hexaconazole, (II-A050) imibenconazole, (II-A051) penconazole, (II-A052) simeconazole, (II-A053) triadimefon, (II-A054) uniconazole, (II-A055) pyributicarb, (II-A056) dodemorph, (II-A057) aldimorph, (II-A058) trimorphamide, (II-A059) piperalin, (II-A060) naftifine;
(II-B) inhibitors of the respiratory chain at complex I or II, for example, (II-B001) benzovindiflupyr, (II-B002) bixafen, (II-B003) boscalid, (II-B004) carboxin, (II-B005) fluopyram, (II-B006) flutolanil, (II-B007) fluxapyroxad, (II-B008) furametpyr, (II-B009) isofetamid, (II-B010) isopyrazam, (II-B011) penflufen, (II-B012) penthiopyrad, (II-B013) pydiflumetofen, (II-B014) pyraziflumid, (II-B015) sedaxane, (II-B016) inpyrfluxam, (II-B017) fluindapyr, (II-B018) isoflucypram, (II-B019) diflumetorim, (II-B020) thifluzamide;
(II-C) inhibitors of the respiratory chain at complex III, for example, (II-C001) ametoctradin, (II-C002) amisulbrom, (II-C003) azoxystrobin, (II-C004) coumethoxystrobin, (II-C005) coumoxystrobin, (II-C006) cyazofamid, (II-C007) dimoxystrobin, (II-C008) enoxastrobin, (II-C009) famoxadone, (II-C010) fenamidone, (II-C011) flufenoxystrobin, (II-C012) fluoxastrobin, (II-C013) kresoxim-methyl, (II-C014) metominostrobin, (II-C015) orysastrobin, (II-C016) picoxystrobin, (II-C017) pyraclostrobin, (II-C017) metarylpicoxamid, (II-C018) pyrametostrobin, (II-C019) pyraoxystrobin, (II-C020) trifloxystrobin, (II-C021) fenpicoxamid, (II-C022) mandestrobin, (II-C023) metyltetraprole, (II-C024) florylpicoxamid, (II-C025) pyribencarb;
(II-D) inhibitors of the mitosis and cell division, for example, (II-D001) carbendazim, (II-D002) diethofencarb, (II-D003) ethaboxam, (II-D004) fluopicolide, (II-D005) pencycuron, (II-D006) thiabendazole, (II-D007) thiophanate-methyl, (II-D008) zoxamide, (II-D009) benomyl;
(II-E) compounds capable of having a multisite action, for example, (II-E001) bordeaux mixture, (II-E002) captafol, (II-E003) captan, (II-E004) chlorothalonil, (II-E005) copper hydroxide, (II-E006) copper naphthenate, (II-E007) copper oxide, (II-E008) copper oxychloride, (II-E009) copper sulfate, (II-E010) dithianon, (II-E011) dodine, (II-E012) folpet, (II-E013) mancozeb, (II-E014) maneb, (II-E015) metiram, (II-E016) metiram zinc, (II-E017) oxine-copper, (II-E018) propineb, (II-E019) sulfur and sulfur preparations including calcium polysulfide, (II-E020) thiram, (II-E021) zineb, (II-E022) ziram, (II-E023) quinomethionate, (II-E024) ferbam, (II-E025) dichlofluanid, (II-E026) tolylfluanid, (II-E027) guazatine, (II-E028) iminoctadine, (II-E029) anilazine;
(II-F) compounds capable of inducing a host defense, for example, (II-F001) acibenzolar-S-methyl, (II-F002) isotianil, (II-F003) probenazole, (II-F004) tiadinil;
(II-G) inhibitors of the amino acid and/or protein biosynthesis, for example, (II-G001) cyprodinil, (II-G002) kasugamycin, (II-G003) kasugamycin hydrochloride hydrate, (II-G004) oxytetracycline, (II-G005) pyrimethanil, (II-G006) 3-(5-fluoro-3,3,4,4-tetramethyl-3,4-dihydroisoquinolin-1-yl)quinoline, (II-G007) fuberidazole, (II-G008) thiophanate, (II-G009) blasticidin-S, (II-G010) streptomycin, (II-G011) mepanipyrim;
(II-H) inhibitors of the ATP production, for example, (II-H001) silthiofam, (II-H002) fentin acetate, (II-H003) fentin chloride, (II-H004) fentin hydroxide;
(II-I) inhibitors of the cell wall synthesis, for example, (II-I001) benthiavalicarb, (II-I002) dimethomorph, (II-I003) flumorph, (II-I004) iprovalicarb, (II-I005) mandipropamid, (II-I006) pyrimorph, (II-I007) valifenalate,
(II-J) inhibitors of the lipid and membrane synthesis, for example, (II-J001) propamocarb, (II-J002) propamocarb hydrochloride, (II-J003) tolclofos-methyl, (II-J004) difenphos, (II-J005) iodocarb, (II-J006) prothiocarb, (II-J007) edifenphos, (II-J008) iprobenfos, (II-J009) pyrazophos, (II-J010) isoprothiolane, (II-J011) etridiazole, (II-J012) biphenyl, (II-J013) chloroneb, (II-J014) dicloran, (II-J015) quintozene, (II-J016) tecnazene;
(II-K) inhibitors of the melanine biosynthesis, for example, (II-K001) tricyclazole, (II-K002) pyroquilon, (II-K003) carpropamid, (II-K004) diclocymet, (II-K005) fenoxanil, (II-K006) fthalide;
(II-L) inhibitors of the nucleic acid synthesis, for example, (II-L001) benalaxyl, (II-L002) benalaxyl-M (kiralaxyl), (II-L003) metalaxyl, (II-L004) metalaxyl-M (mefenoxam), (II-L005) ethirimol, (II-L006) furalaxyl, (II-L007) ofurace, (II-L008) oxolinic acid, (II-L009) hymexazole, (II-L010) octhilinone, (II-L011) bupirimate, (II-L012) dimethirimol;
(II-M) inhibitors of the signal transduction, for example, (II-M001) fludioxonil, (II-M002) iprodione, (II-M003) procymidone, (II-M004) proquinazid, (II-M005) quinoxyfen, (II-M006) vinclozolin, (II-M007) chlozolinate, (II-M008) fenpiclonil, (II-M009) proquinazid;
(II-N) compounds capable of acting as uncoupler, for example, (II-N001) fluazinam, (II-N002) meptyldinocap, (II-N003) binapacryl, (II-N004) dinocap;
(II-O) other fungicides, for example, (II-O001) abscisic acid, (II-O002) benthiazole, (II-O003) bethoxazin, (II-O004) capsimycin, (II-O005) carvone, (II-O006) chinomethionat, (II-O007) cufraneb, (II-O008) cyflufenamid, (II-O009) cymoxanil, (II-O010) cyprosulfamide, (II-O011) flutianil, (II-O012) fosetylaluminium, (II-O013) fosetyl-calcium, (II-O014) fosetyl-sodium, (II-O015) methyl isothiocyanate, (II-O016) metrafenone, (II-O017) mildiomycin, (II-O018) natamycin, (II-O019) nickel dimethyldithiocarbamate, (II-O020) nitrothal-isopropyl, (II-O021) oxamocarb, (II-O022) oxathiapiprolin, (II-O023) oxyfenthiin, (II-O024) pentachlorophenol and salts, (II-O025) phosphorous acid and its salts, (II-O026) propamocarb-fosetylate, (II-O027) pyriofenone (chlazafenone), (II-O028) tebufloquin, (II-O029) tecloftalam, (II-O030) tolnifanide, (II-O031) quinofumelin, (II-O032) pyridachlometyl, (II-O033) ipflufenoquin, (II-O034) aminopyrifen, (II-O035) methasulfocarb, (II-O036) nabam, (II-O037) oxine copper, (II-O038) ditalimfos, (II-O039) drazoxolon, (II-O040) tolyfluanide, (II-O041) diclobutrazol, (II-O042) cyprofuram, (II-O043) phophorous acid and salts, (II-0044) ferimzone, (II-O045) pyrrolnitrin, (II-O046) triazoxide, (II-O047) flusulfamide, (II-O048) diclomezine, (II-O049) mineral oils, (II-O050) organic oils, (II-O051) inorganic oils, (II-O052) potassium bicarbonate, (II-O053) ferric methanearsonate;
(II-P) HDAC inhibitors, for example, (II-P001) flufenoxadiazam;
(II-Q) compounds capable to act as a safener, for example, (II-Q001) benoxacor, (II-Q002) furilazole, (II-Q003) isoxadifenethyl; (II-Q004) cloquintocet-mexyl, (II-Q005) cumyluron, (II-Q006) cyometrinil, (II-Q007) daimuron, (II-Q008) dichlormid, (II-Q009) dicyclonon, (II-Q010) dietholate, (II-Q011) dimepiperate, (II-Q012) fenchlorazole-ethyl, (II-Q013) fenclorim, (II-Q014) flurazole, (II-Q015) fluxofenim, (II-Q016) furilazole, (II-Q017) isoxadifen-ethyl, (II-Q018) mefenpyr-diethyl, (II-Q019) mephenate, (II-Q020) methoxyphenone, (II-Q021) naphthalic anhydride, (II-Q022) oxabetrinil, (II-Q023) cyprosulfamide; and
(II-R) biological fungicides, for example, (II-R001) Bacillus subtilis syn., (II-R002) Bacillus subtilis strain QST713, (II-R003) Bacillus subtilis strain BU1814, (II-R004) Bacillus subtilis var. amyloliquefaciens strain FZB24, (II-R005) Bacillus amyloliquefaciens strain MBI600, (II-R006) Bacillus amyloliquefaciens strain D747, (II-R007) Bacillus amyloliquefaciens strain D727, (II-R008) Bacillus amyloliquefaciens strain ENV503, (II-R009) Tricoderma atroviride strain SCi, (II-R010) Bacillus mycoides isolate, (II-R011) Pseudomonas chlororaphis strain AFS009, (II-R012) Streptomyces lydicus strain WYEC108, (II-R013) Aureobasidium pullulans strain DSM 14940+Pullulans strain DSM 14941, (II-R014) extract from Melameuca alternifolia, (II-R015) Swinglea glutinosa extract, (II-R016) calcium salt of phosphorus acid/calcium phosphite, (II-R017) Streptomyces hygroscopicus (validamycin), (II-R018) Bacillus altudinis, (II-R019) Bacillus amyloliquefaciens, (II-R020) Bacillus amyloliquefaciens ssp. plantarum MBI600, (II-R021) Bacillus amyloliquefaciens ssp. plantarum D747, (II-R022) Bacillus megaterium, (II-R023) Bacillus mojavensis, (II-R024) Bacillus mycoides, (II-R025) Bacillus pumilus INR-7, (II-R026) Bacillus pumilus GHA 180, (II-R027) Bacillus simplex, (II-R028) Bacillus solisalsi, (II-R029) Burkholderia sp., (II-R030) Clavibacter michiganensis (bacteriophages), (II-R031) Gliocladium roseum, (II-R032) Microsphaeropsis ochracea, (II-R033) Muscodor albus, (II-R034) Paenibacillus alvei, (II-R035) Paenibacillus polymyxa, (II-R036) Pantoea agglomerans, (II-R037) Pantoea vagans, (II-R038) Penicillium bilaiae, (II-R039) Pseudomonas sp., (II-R040) Pseudomonas chloraphis, (II-R041) Pseudomonas fluorescens, (II-R042) Sphaerodes mycoparasitica, (II-R043) Streptomyces violaceusniger, (II-R044) Trichoderma fertile JM41R, (II-R045) Typhula phacorrhiza, (II-R046) Verticillium dahlia, (II-R047) zucchini yellow mosaic virus (avirulent strain).

In a preferred embodiment, the fungicide as used in the composition/combination of the present invention is selected from the group consisting of
(II-A) inhibitors of the sterol biosynthesis, for example, (II-A001) cyproconazole, (II-A002) difenoconazole, (II-A003) epoxiconazole, (II-A004) fenhexamid, (II-A005) fenpropidin, (II-A006) fenpropimorph, (II-A007) fenpyrazamine, (II-A008) fluquinconazole, (II-A009) flutriafol, (II-A010) imazalil, (II-A011) imazalil sulfate, (II-A012) ipconazole, (II-A013) metconazole, (II-A014) myclobutanil, (II-A015) paclobutrazol, (II-A016) prochloraz, (II-A017) propiconazole, (II-A018) prothioconazole, (II-A019) pyrisoxazole, (II-A020) spiroxamine, (II-A021) tebuconazole, (II-A022) tetraconazole, (II-A023) triadimenol, (II-A024) tridemorph, (II-A025) triticonazole, (II-A026) mefentrifluconazole, (II-A027) ipfentrifluconazole, II-A028) terbinafine, (II-A029) buthiobate, (II-A030) pyrifenox, (II-A031) fenarimol, (II-A032) nuarimol, (II-A033) triarimol, (II-A034) triforine, (II-A035) clotrimazole, (II-A036) econazole, (II-A037) isoconazole, (II-A038) miconazole, (II-A039) oxpoconazole, (II-A040) pefurazoate, (II-A041) triflumizole, (II-A042) azaconazole, (II-A043) bitertanol, (II-A044) bromuconazole, (II-A045) diniconazole, (II-A046) diniconazole-M, (II-A047) etaconazole, (II-A048) fenbuconazole, (II-A049) hexaconazole, (II-A050) imibenconazole, (II-A051) penconazole, (II-A052) simeconazole, (II-A053) triadimefon, (II-A054) uniconazole, (II-A055) pyributicarb, (II-A056) dodemorph, (II-A057) aldimorph, (II-A058) trimorphamide, (II-A059) piperalin, (II-A060) naftifine.

In more preferred embodiment, the present invention provides a synergistic combination comprising:
a) flubendiamide or acceptable salt(s) thereof;
b) at least one seaweed extract; and
c) hexaconazole or acceptable salt(s) thereof.

The ratio of flubendiamide or acceptable salt(s) thereof, at least one seaweed extract, and at least one additional active ingredient is from (1-100):(1-100):(1-100), more preferably (1-50):(1-50):(1-50), most preferably (1-20):(1-20):(1-20).

In one embodiment, the present invention provides a synergistic combination comprising:
a) flubendiamide or acceptable salt(s) thereof;
b) at least one seaweed extract;
c) at least one insecticide; and
d) at least one fungicide.

The ratio of flubendiamide or acceptable salt(s) thereof, at least one seaweed extract, at least one insecticide, and at least one fungicide is from (1-100):(1-100):(1-100):(1-100), more preferably (1-50):(1-50):(1-50):(1-50), most preferably (1-20):(1-20):(1-20):(1-20).

In one embodiment, the present invention provides a composition comprising a synergistic combination according to any one of the above-described embodiments, and at least one agriculturally acceptable carrier(s).

The composition comprising organic or inorganic carrier material, including agriculturally acceptable additive(s) are selected from solid carrier(s), liquid carrier(s), gaseous carrier(s), surfactant(s), emulsifier(s), binder(s), disintegrating agent(s), pH adjuster(s), thickener(s), preservative(s), anti-caking agent(s), anti-freezing agent(s), defoaming agent(s), extender(s), stabilizer(s) and/or coloring agent(s) or a combination thereof. The composition may also contain if desired, one or more auxiliaries customary for crop protection compositions.

Solid carrier(s) is selected from the group consisting of, but not limited to, natural minerals such as quartz, talc, kaolin, kaolin clay, pyrophyllite, montmorillonite, attapulgite, bentonite, chalk, zeolite, calcite, sericite, clay, acid clay, diatomaceous earth, Fuller's earth, meerschaum, gibbsite, dolomite or pumice; synthetic minerals such as precipitated silica, fumed silica, sodium silicate, alumina, aluminum hydroxide; inorganic salts such as calcium carbonate, ammonium sulfate, sodium sulfate, potassium chloride, organic materials such as urea, solid polyoxyethylene, solid polyoxypropylene, polyethylene, polypropylene, lactose, starch, lignin, cellulose, cottonseeds hulls, wheat flour, soyabean flour, wood flour, walnut shell flour, plant powders, sawdust, coconut shellflower, corn cob, tobacco stem. These solid carriers may be used alone or in combination.

Liquid carrier(s) is selected from the group consisting of, but not limited to, water; alcohols such as ethanol, propanol, butanol, n-octanol, isopropanol ethylene glycol, diethylene glycol, propylene glycol, polyethylene glycol, benzyl alcohol, glycerin; polyol ethers such as ethylene glycol monopropyl ether, diethylene glycol monomethyl ether, dipropylene glycol dimethyl ether; ketones such as acetone, methyl ethyl ketone, methyl isobutyl ketone, cyclohexanone; ethers such as dipropyl ether, dioxane, tetrahydrofuran, aliphatic hydrocarbons such as normal paraffin, isoparaffin, kerosene, mineral oil; aromatic hydrocarbons such as xylene, toluene, naphthene, solvent naphtha, solvent C9, solvent C10, solvent C12, solvesso 100, solvesso 150, solvesso 200; chlorinated aliphatic or aromatics hydrocarbons such as chlorobenzene, chloroethylene, methylene chloride; esters such as ethyl acetate, diisopropyl phthalate, dimethyl adipate, methyl oleate, methyl tallowate; lactones such as gamma-butyrolactone, gamma-valerolactone, epsilon-caprolactone; amides such as dimethylformamide, N-methylpyrrolidone, N-octylpyrolidone, N,N-dimethyldecanamide; nitriles such as acetonitrile; organosulfur compound such as dimethyl sulfoxide; vegetable oils such as soybean oil, rapeseed oil, cotton seed oil. These liquid carriers may be used alone or in combination.

Gaseous carrier(s) is selected from the group consisting of, but not limited to, liquefied petroleum gas, air, nitrogen, carbon dioxide or dimethyl ether. These gaseous carriers may be used alone or in combination thereof.

Surfactant(s) (a dispersing agent, a wetting agent, a spreader, an adjuvant for penetration enhancement, rain fastness, soil leaching control etc.) are nonionic or anionic surfactants or a combination of these surfactants. It is preferred to use one or more than one kind of surfactant. Surfactant(s) is selected from the group consisting of, but not limited to, sugar esters such as sorbitan monolaurate, long chain alcohol ethoxylate, long chain nonyl phenol alcohol ethoxylate, sodium dodecyl sulphate, ufoxane 30, alphox 215, polyoxyethylene sorbitan monolaurate; C1-C30 alkylcarboxylate, C1-C20 hydroxyalkylcarboxylate, polymer containing carboxylate, arylcarboxylate, alkylx (e.g. aliphatic di- and tricarboxylates) having 2 to 32 carbon atoms, such as aconitic acid, adipic acid, aspartic acid, citric acid, fumaric acid, galactaric acid, glutamic acid, glutaric acid, oxoglutaric acid, maleic acid, malic acid, malonic acid, oxalate, sebacic acid, succinic acid, tartaric acid; alkyl polyglucoside such as decyl glucoside; polyoxyethylene alkyl ethers such as polyoxyethylene lauryl ether, or polyoxyethylene coconut fatty alcohol ether; polyoxyethylene alkynyl ether such as polyoxyethylene 2,4,7,9-tetramethyl-5-decyn-4,7-diol ether; polyoxyethylene aryl ethers such as polyoxyethylene nonylphenyl ether or polyoxyethylene tristyrylphenyl ether; polyoxyethylene vegetable oil ethers such as polyoxyethylene castor oil or polyoxyethylene hydrogenated castor oil; vegetable oil ethoxylate; C6-C20 linear and branched alcohol ethoxylates, C6-C20 alcohol propoxylates, C6-C20 propoxylated and ethoxylated alcohols; polyoxyethylene fatty acid esters such as polyoxyethylene monolaurate, polyoxyethylene distearate or polyoxyethylene resin acid ester; polyoxyethylene polyoxypropylene (EO-PO) block co-polymers such as Pluronic®, Genapol PF 80; polyoxyethylene polyoxypropylene alkyl ether such as polyoxyethylene polyoxypropylene lauryl ether; polyoxyethylene polyoxypropylene aryl ether such as polyoxyethylene polyoxypropylene styrylphenyl ether; polyoxyethylene alkyl amines such as polyoxyethylene stearyl amine; polyoxyethylene fatty acid amide such as lauric acid diethanolamid; fluorinated surfactant; alkyl sulfates such as sodium lauryl sulfate; sodium alkylbenzene sulfonate, calcium alkylbenzene sulphonate; polyoxyethylene alkyl ether sulfates such as sodium polyoxyethylene lauryl ether sulfate; polyoxyethylene aryl ether sulfates such as sodium polyoxyethylene nonylphenyl ether sulfate or ammonium polyoxyethylene tristyrylphenyl ether sulfate; aryl sulfonate such as calcium benzene sulfonate calcium dodecyl benzene sulfonate, sodium naphthalene sulfonate, sodium salt of naphthalene sulfonate condensate (MORWET® D-425) or sodium naphthalene sulfonate formaldehyde condensate; poly aryl phenyl ether sulphate ammonium salt; ‘alpha’-olefin sulfonate; lauryl sulfosuccinate, laureth sulfosuccinate, laureth-5 sulfosuccinate, ricinoleamide MEA sulfosuccinate, undecylenearnide MEA sulfosuccinate, diisobutyl sulfosuccinate, dioctyl sulfosuccinate, dihexyl sulfosuccinate, dicyclohexyl sulfosuccinate, diisodecyl sulfosuccinate, diisotridecyl sulfosuccinate, di-2-ethylhexyl sulfosuccinate, di-2-methylamyl sulfosuccinate, dimethylamyl sulfosuccinate, dibutylhexyl sulfosuccinate, diisooctyl sulfosuccinate or their alkali metal salts, sodium lignosulfonate; polycarboxylic acid sodium salt; N-methyl fatty acid sarcosinate; polyoxyethylene alkyl ether phosphate; polyoxyethylene aryl ether phosphates such as polyoxyethylene phenyl ether phosphate; polyoxyethylene alkyl phenyl ether phosphate; graft co-polymers such as polymethyl methacrylate-polyethylene glycol graft copolymer. These surfactants may be used alone or in combination thereof.

Binder(s) or adhesive-imparting agent(s) is selected from the group consisting of, but not limited to, polyvinyl alcohol, dextrin, denatured dextrin, soluble starch, guar gum, xanthan gum, sucrose, polyvinylpyrrolidone, gum arabic, polyvinyl acetate, sodium polyacrylate, carboxymethyl cellulose or its salt, carboxymethylcellulose dextrin, bentonite, polyethylene glycol having an average molecular weight of 6,000 to 20,000, polyethylene oxide having average molecular weight of 100,000 to 5,000,000, natural phosphatide such as cephalinic acid or lecithin. These binders or adhesive-imparting agents may be used alone or in combination thereof.

Disintegrating agent(s) is selected from the group consisting of, but not limited to, sodium tripolyphosphate, stearic acid metal salt, cellulose powder, dextrin, methacrylate co-polymer, polyvinylpyrrolidone, polyaminocarboxylic acid chelate compound, styrene sulfonate/isobutylene/maleic anhydride co-polymer, starch/polyacrylonitrile graft co-polymer, sodium hexametaphosphate, carboxymethyl cellulose, sodium polycarbonate, bentonite. These disintegrating agents may be used alone or in combination thereof.

pH adjuster(s) is selected from the group consisting of, but not limited to, sodium or potassium carbonate, sodium or potassium hydrogen carbonate, sodium or potassium dihydrogenphosphate, disodium or dipotassium hydrogenphosphate, citric acid, malic acid and triethanolamine. These pH adjusters may be used alone or in combination thereof.

Thickener(s) is selected from the group consisting of, but not limited to, polyvinyl alcohol, carboxymethylcellulose, polyvinylpyrrolidone, carboxyvinyl polymer, acrylic polymer, acrylic graft copolymer, starch derivative, synthetic macromolecules, such as modified cellulose-based polymers, polycarboxylates, montmorillonites, hectonites, attapulgites, polysaccharide gums such as gellan gum, jelutong gum, xanthan gum, guar gum, gum arabic, gum tragacanth, gum karya, tara gum, locust gum, agar agar, carrageenan, alginic acid, propylene glycol alginate, alginates (e.g. sodium, potassium, ammonium, or calcium), or an inorganic fine powder selected from high purity silica, bentonite, white carbon. These thickeners may be used alone or in combination thereof.

Preservative(s) is selected from the group consisting of, but not limited to, formaldehyde and paraformaldehyde, 2-hydroxybiphenyl ether and its salts, 2-zinc sulfidopyridine N-oxide, inorganic sulfites and bisulfites, sodium iodate, chlorobutanol, dehydroacetic acid, formic acid, 1, 6-bis (4-amidino-2-bromophenoxy)-n-hexane and its salts, 10-undecylenic acid and their salts, 5-amino-1,3-bis (2-ethylhexyl)-5-methyl-hexahydropyrimidine, 5-bromo-5-nitro-1,3-dioxane, 2-bromo-2-nitro-1,3 propanediol, 2,4-dichlorobenzylalcohol, potassium sorbate, 4-hydroxybenzoic acid esters, dichlorophene, isothiazolenes and isothiazolones such as 1,2-benzisothiazol-3(2H)-one (Proxel® GXL), 2-methyl-2H-isothiazol-3-one-hydrochloride, 5-chloro-2-(4-chlorobenzyl)-3(2H)-isothiazolone, 5-chloro-2-methyl-2H-isothiazol-3-one, 5-chloro-2-methyl-2H-isothiazol-3-one, 5-chloro-2-methyl-2H-isothiazol-3-one-hydrochloride, 4,5-dichloro-2-cyclohexyl-4-isothiazolin-3-one, 4,5-dichloro-2-octyl-2H-isothiazol-3-one, 2-methyl-2H-isothiazol-3-one, 2-methyl-2H-isothiazol-3-one-calcium chloride complex, 2-octyl-2H-isothiazol-3-one. These preservatives may be used alone or in combination thereof.

Anti-caking agent(s) is selected from the group consisting of, but not limited to, disodium benzene disulfonate, dipotassium benzene disulfonate, disodium toluene disulfonate, and dipotassium toluene disulfonate, glycol based aqueous solvents such as ethylene glycol, diethylene glycol, dipropylene glycol and propylene glycol, precipitated silica, fumed silica, aluminium silicate, magnesium silicate, sodium silicate, calcium silicate, talc, diatomaceous earth, bentonite, calcium carbonate, sodium carbonate, aluminium oxide, and talcum, cellulose, attapulgite clay, kieselguhr, silica aerogel, silica xerogel, perlite, talc, vermiculite, sodium aluminosilicate, zirconium oxychloride, starch, sodium or potassium phthalate, calcium phosphate, calcium nitride, aluminum nitride, copper oxide, magnesium carbonate, magnesium nitride, magnesium phosphate, magnesium oxide, magnesium nitrate, magnesium sulfate, magnesium chloride, magnesium oxide, magnesium and aluminum salts of C10-C22 fatty acids such as palmitic acid, stearic acid and oleic acid, tricalcium phosphate, hydrophobic starch derivatives, powdered cellulose, polyacrylic acid and sodium salts thereof, and sodium polyalkyl naphthalene sulfonate. These anti-caking agents may be used alone or in combination thereof.

Anti-freezing agent(s) is selected from the group consisting of, but not limited to, urea, glycerine, ethylene glycol, diethylene glycol, triethylene glycol, tetraethylene glycol, trimethylene glycol, 1,2-butanediol, 1,3-butanediol, 1,4-butanediol, 1,4-pentanediol, 3-methyl-1,5-pentanediol, 2,3-dimethyl-2,3-butanediol, trimethylol propane, mannitol, sorbitol, glycerol, pentaerythritol, 1,4-cyclohexanedimethanol, xylenol, bisphenols such as bisphenol A or the like, propylene glycol, glycerol, diethylene glycol monomethyl ether, diethylene glycol monoethyl ether, triethylene glycol monomethyl ether, butoxyethanol, butylene glycol monobutyl ether, dipentaerythritol, tripentaerythritol, tetrapentaerythritol, diglycerol, triglycerol, tetraglycerol, pentaglycerol, hexaglycerol, heptaglycerol and octaglycerol. These anti-freezing agents may be used alone or in combination thereof.

Defoamer(s) is selected from the group consisting of, but not limited to, silicone compounds such as polysiloxane, polydimethyl siloxane, silicone oil, magnesium stearate, long chain alcohol, fatty acid, salts of fatty acid and organic fluorine compounds. These defoaming agents may be used alone or in combination thereof.

Extender(s) is selected from the group consisting of, but not limited to, silicon type surfactant, a cellulose powder, dextrin, processed starch, a polyaminocarboxylic acid chelate compound, crosslinked polyvinylpyrrolidone, maleic acid and styrene, methacrylic acid co-polymer, half ester of polymer of polyhydric alcohol with dicarboxylic anhydride, water-soluble salt of polystyrene sulfonic acid. These extenders may be used alone or in combination thereof.

Stabilizer(s) is selected from the group consisting of, but not limited to, drying agent such as zeolite, quick lime or magnesium oxide; antioxidant agent such as phenol type, amine type, sulfur type or phosphorus type; or ultraviolet absorber such as salicylic acid type or a benzophenone type. These stabilizers may be used alone or in combination thereof.

Coloring agent(s) is selected from the group consisting of, but not limited to, inorganic pigment such as iron oxide, titanium oxide or Prussian blue; organic dye such as alizarin dye, azo dye, metal phthalocyanine dye. These coloring agents may be used alone or in combination thereof.

In an embodiment, the total amount of flubendiamide or acceptable salt(s) thereof in the composition may typically be in the range of 0.1 to 99% by weight, preferably 0.2 to 90% by weight. The total amount of the seaweed extracts in the composition may be in the range of 0.1 to 99% by weight, preferably 0.2 to 90% by weight.

When additive ingredients are incorporated into the composition of the present invention, the content of the carrier is selected typically in weight range from 5% to 95%, preferably from 20% to 90%; the content of the surfactant is selected from the range of typically from 0.1% to 30%, preferably from 0.5% to 10%, and the content of the other additives is selected from the range of typically from 0.1% to 50%.

The composition of the present invention provides may typically be produced by mixing the actives in the composition with an inert carrier(s) as needed and formulated into either solid or liquid formulations that are suitable for application. The formulations may be made in known formulation types such as wettable powder (WP), a water dispersible granule (WG or WDG), a water dispersible tablet (WT), granule (GR), an emulsifiable granule (EG), a water soluble powder (SP), an ultra-low volume (ULV) liquid (UL), an ultra-low volume (ULV) suspension (SU), a soluble concentrate (SL), a water soluble granule (SG), a suspo-emulsion (SE), an oil-in-water emulsion (EW), an emulsifiable concentrate (EC), a micro-emulsion (ME), an oil dispersion (OD), a capsule suspension (CS), an aerosol (AE), a mixed formulation of CS and SE (ZE), a mixed formulation of CS and SW (ZW) or a mixed formulation of CS and SC (ZC).

These compositions may be manufactured by any process known in the art, such as, “Pesticide Formulation Guide” (edited by Pesticide Science Society of Japan, The Agricultural Formulation and Application Committee, published by Japan Plant Protection Association, 1997).

In one embodiment, the present invention provides a process for the preparation of composition of flubendiamide and seaweed extracts, comprising the steps of:
a) adding flubendiamide or acceptable salt(s) thereof and seaweed extracts and optionally, at least one additional active selected from insecticides, acaricides, nematicides, fungicides, herbicides or mixtures thereof;
b) adding agrochemically acceptable additives selected from surfactant(s), carrier(s) and other additive(s) uniformly in a mixer; and optionally milling by a mill.

In preferred embodiment, the present invention provides a water dispersible granule (WDG) composition of flubendiamide and seaweed extracts.

In another preferred embodiment, the present invention provides a water dispersible granule (WDG) composition of flubendiamide and Ascophyllum nodosum.

In one embodiment, the present invention provides a process for preparing water dispersible granules (WDG) formulation, comprising steps of:
a) pre-blending of flubendiamide and Ascophyllum nodosum and optionally, at least one additional active selected from insecticides, acaricides, nematicides, fungicides, herbicides or mixtures thereof with wetting agent(s), dispersing agent(s), disintegrating agent(s), and inert filler,
b) micronizing pre-blended mixture in air jet mill to get the desired particle size,
c) preparing the dough by employing an alcohol; and
d) extruding using an extruder and drying under vacuum to obtain water dispersible granules.

In another embodiment, the present invention provides a suspension concentrate (SC) composition of flubendiamide and seaweed extracts.

In yet another embodiment, the present invention provides a suspension concentrate (SC) composition of flubendiamide and Ascophyllum nodosum.

In yet another embodiment, the present invention provides a water dispersible granule (WDG) composition of flubendiamide, profenpfos and Ascophyllum nodosum.

In yet another embodiment, the present invention provides a suspo-emulsion (SE) composition of flubendiamide, profenpfos and Ascophyllum nodosum.

The combinations of the present invention are effective to control unwanted pests such as insects, mites and/or unwanted acarids.

The combination of the present invention provides a method for improving crop health (phyto-tonic effect).

The combination of the present invention provides a longer residual control of unwanted insect pests and mites and/or unwanted acarids.

The insect pests or mites are selected from the order of moths and butterflies (Lepidoptera), beetles (Coleoptera), flies, mosquitoes (Diptera), thrips (Thysanoptera), termites (Isoptera), cockroaches (Blattaria-Blattodea), true bugs (Hemiptera), crickets, grasshoppers, locusts (Orthoptera), arachnids (Acarina), fleas (Siphonaptera), silverfish, firebrat (Thysanura), millipedes (Diplopoda), earwigs (Dermaptera), lice (Phthiraptera), or plant parasitic nematodes.

In a further embodiment of the present invention defines the insect pests and mites from the orders of: lepidopterans (Lepidoptera), for example Agrotis ipsilon, Agrotis segetum (cutworm), Alabama argillacea, Anticarsia gemmatalis, Argyresthia conjugella, Autographa gamma, Bupalus piniarius, Cacoecia murinana, Capua reticulana, Cheimatobia brumata, Choristoneura fumiferana, Choristoneura occidentalis, Cirphis unipuncta, Cydia pomonella, Cydia caryana (hickory shuckworm), Dendrolimus pini, Diaphania nitidalis, Diatraea grandosella, Earias insulana, Elasmopalpus lignosellus, Eupoecilia ambiguella, Evetria bouliana, Feltia subterranea, Galleria mellonella, Grapholitha funebrana, Grapholitha molesta, Heliothis armigera, Heliothis virescens (tobacco budworm), Heliothis zea, Hellula undalis, Hiberniadefoliaria, Hyphantria cunea, Hyponomeuta malinellus, Keiferia lycopersicella, Lambdina fiscellaria, Laphygma exigua, Leucoptera coffeella, Leucoptera scitella, Lithocolletis blancardella, Lobesia botrana, Loxostege sticticalis, Lymantria dispar, Lymantria monacha, Lyonetia clerkella, Malacosoma neustria, Mamestra brassicae, Orgyia pseudotsugata, Ostrinia nubilalis (european corn borer), Panolis flammea, Pectinophora gossypiella (pink bollworm), Peridroma saucia, Phalera bucephala, Phthorimaea operculella, Phyllocnistis citrella, Pieris brassicae, Pieris rapae (imported cabbageworm), Plathypena scabra, Plutella xylostella, Pseudoplusia includens, Rhyacionia frustrana, Scrobipalpula absoluta, Sitotroga cerealella, Sparganothis pilleriana, Spodoptera frugiperda (fall armyworm), Spodoptera littoralis, Spodoptera litura, Thaumatopoea pityocampa, Tortrix viridana, Trichoplusia ni, Zeiraphera canadensis, Giant swallowtail (orangedog), Paralobesia viteana (grape berry moth), Desmia funeralis (grape leaffolder), Helicoverpa zea (corn earworm), Helicoverpa armigeral (cotton bollworm), Agrotis segetum, Agrotis ipsilon, Agrotis exclamationis, Manduca quinquemaculata (tomato hornworm), Lithophane antennata (green fruitworm), Lithophane unimoda, Orthosia hibisci, Anarsia lineatella (peach twig borer), Acrobasis nuxvorella (pecan nut casebearer), Amyelois transitella (navel orangeworm), Marmara gulosa (Citrus peelminer) and Harrisina Americana (Grapeleaf skeletonizer),
beetles (Coleoptera), for example Agrilus sinuatus, Agriotes lineatus, Agriotes obscurus, Amphimallus solstitialis, Anisandrus dispar, Anthonomus grandis, Anthonomus pomorum, Aphthona euphoridae, Athous haemorrhoidalis, Atomaria linearis, Blastophagus piniperda, Blitophaga undata, Bruchus rufimanus, Bruchus pisorum, Bruchus lentis, Byctiscus betulae, Cassida nebulosa, Cerotoma trifurcata, Cetonia aurata, Ceuthorrhynchus assimilis, Ceuthorrhynchus napi, Chaetocnema tibialis, Conoderus vespertinus, Crioceris asparagi, Ctenicera ssp., Curculio caryae (pecan weevil), Diabrotica longicornis, Diabrotica semipunctata, Diabrotica 12-punctata, Diabrotica speciosa, Diabrotica virgifera, Epilachna varivestis, Epitrix hirtipennis, Eutinobothrus brasiliensis, Hylobius abietis, Hypera brunneipennis, Hypera postica, Ips typographus, Lema bilineata, Lema melanopus, Leptinotarsa decemlineata (colorado potato beetle), Limonius califomicus, Lissorhoptrus oryzophilus, Melanotus communis, Meligethes aeneus, Melolontha hippocastani, Melolontha melolontha, Oulema oryzae, Ortiorrhynchus sulcatus, Otiorrhynchus ovatus, Phaedon cochleariae, Phyllobius pyri, Phyllotreta chrysocephala, Phyllophaga sp., Phyllopertha horticola, Phyllotreta nemorum, Phyllotreta striolata, Popillia japonica (Japanese beetle), Sitona lineatus, Sitophilus granaria, Diaprepes abbreviatus, and Conotrachelus nenuphar (plum curculio),
flies, mosquitoes (Diptera), e.g. Aedes aegypti, Aedes albopictus, Aedes vexans, Anastrepha ludens, Anopheles maculipennis, Anopheles crucians, Anopheles albimanus, Anopheles gambiae, Anopheles freeborni, Anopheles leucosphyrus, Anopheles minimus, Anopheles quadrimaculatus, Calliphora vicina, Ceratitis capitata, Chrysomya bezziana, Chrysomya hominivorax, Chrysomya macellaria, Chrysops discalis, Chrysops silacea, Chrysops atlanticus, Cochliomyia hominivorax, Contarinia sorghicola Cordylobia anthropophaga, Culicoides furens, Culex pipiens, Culex nigripalpus, Culex quinquefasciatus, Culex tarsalis, Culiseta inornata, Culiseta melanura, Dacus cucurbitae, Dacus oleae, Dasineura brassicae, Delia antique, Delia coarctata, Delia platura, Delia radicum, Dermatobia hominis, Drosophila suzukii (spotted wing drosophila), Fannia canicularis, Geomyza Tripunctata, Gasterophilus intestinalis, Glossina morsitans, Glossina palpalis, Glossina fuscipes, Glossina tachinoides, Haematobia irritans, Haplodiplosis equestris, Hippelates spp., Hylemyia platura, Hypoderma lineata, Leptoconops torrens, Liriomyza sativae, Liriomyza trifolii, Lucilia caprina, Lucilia cuprina, Lucilia sericata, Lycoria pectoralis, Mansonia titillanus, Mayetiola destructor, Musca domestica, Muscina stabulans, Oestrus ovis, Opomyza florum, Oscinella frit, Pegomya hysocyami, Phorbia antiqua, Phorbia brassicae, Phorbia coarctata, Phlebotomus argentipes, Psorophora columbiae, Psila rosae, Psorophora discolor, Prosimulium mixtum, Rhagoletis cerasi, Rhagoletis pomonellal (apple maggot), Sarcophaga haemorrhoidalis, Sarcophaga sp., Simulium vittatum, Stomoxys calcitrans, Tabanus bovinus, Tabanus atratus, Tabanus lineola, Tabanus similis, Tipula oleracea, Tipula paludosa, and Rhagoletis cerasi (cherry fruit fly),
thrips (Thysanoptera), e.g. Dichromothrips corbetti, Dichromothrips ssp., Frankliniella fusca, Frankliniella occidentalis, Frankliniella tritici, Scirtothrips citri (Citrus thrips), Thrips oryzae, Thrips palmi, Thrips tabaci, and Drepanothrips reuteri (grape thrips)
termites (Isoptera), e.g. Calotermes flavicollis, Leucotermes flavipes, Heterotermes aureus, Reticulitermes flavipes, Reticulitermes virginicus, Reticulitermes lucifugus, Termes natalensis, and Coptotermesformosanus,
cockroaches (Blattaria-Blattodea), e.g. Blattella germanica, Blattella asahinae, Penplaneta americana, Periplaneta japonica, Periplaneta brunnea, Periplaneta fuligginosa, Periplaneta australasiae, and Blatta orientalis,
true bugs (Hemiptera), e.g. Diaphorina citri, Acrosternum hilare, Blissus leucopterus, Cyrtopeltis notatus, Dysdercus cingulatus, Dysdercus intermedius, Eurygaster integriceps, Euschistus impictiventris, Leptoglossus phyllopus, Lygus lineolaris, Lygus pratensis, Nezara viridula, Piesma quadrata, Solubea insularis, Thyanta perditor, Acyrthosiphon onobrychis, Adelges laricis, Aphidula nasturtii, Aphis fabae, Aphis forbesi, Aphis pomi, Aphis gos sypii, Aphis grossulariae, Aphis schneideri, Aphis spiraecola, Aphis sambuci, Acyrthosiphon pisum, Aulacorthum solani, Bemisia argentifolii, Brachycaudus cardui, Brachycaudus helichrysi, Brachycaudus persicae, Brachycaudus prunicola, Brevicoryne brassicae, Capitophorus horni, Cerosipha gossypii, Chaetosiphon fragaefolii, Cryptomyzus ribis, Dreyfusia nordmannianae, Dreyfusia piceae, Dysaphis radicola, Dysaulacorthum pseudosolani, Dysaphis plantaginea, Dysaphis pyri, Empoasca fabae, Hyalopterus pruni, Hyperomyzus lactucae, Macrosiphum avenae, Macrosiphum euphorbiae, Macrosiphon rosae, Megoura viciae, Melanaphis pyrarius, Metopolophium dirhodum, Myzus persicae, Myzus ascalonicus, Myzus cerasi, Myzus varians, Nasonovia ribis-nigri, Nilaparvata lugens, Pemphigus bursarius, Perkinsiella saccharicida, Phorodon humuli, Psylla mail, Psylla piri, Rhopalomyzus ascalonicus, Rhopalosiphum maidis, Rhopalosiphum padi, Rhopalosiphum insertum, Sappaphis mala, Sappaphis mall, Schizaphis graminum, Schizoneura lanuginosa, Sitobion avenae, Trialeurodes vaporariorum, Toxoptera aurantiiaud, Viteus vitifolii, Cimex lectularius, Cimex hemipterus, Reduvius senilis, Triatoma spp., Cicadella viridis (green leafhoppers), Bactericera cockerelli (potato psyllid), Arilus critatus, Planococcus citri (citrus mealybug), Pseudococcus maritimus (grape mealybug), Pseudatomoscelis seriatus (cotton fleahopper), Proxys punctulatus (black stink bug), Halyomorpha halys, Citricola scale (Coccus pseudomagnoliarum), Barnacle scale (Ceroplastes cirripediformis), and Brown soft scale (Coccus hesperidum),
ants, bees, wasps, sawflies (Hymenoptera), e.g. Athalia rosae, Atta cephalotes, Atta capiguara, Atta cephalotes, Atta laevigata, Atta robusta, Atta sexdens, Atta texana, Crematogaster spp., Hoplocampa minuta, Hoplocampa testudinea, Monomorium pharaonis, Solenopsis geminata, Solenopsis invicta, Solenopsis richteri, Solenopsis xyloni, Pogonomyrmex barbatus, Pogonomyrmex californicus, Pheidole megacephala, Dasymutilla occidentalis, Bombus spp. Vespula squamosa, Paravespula vulgaris, Paravespula pennsylvanica, Paravespula germanica, Dolichovespula maculata, Vespa crabro, Polistes rubiginosa, Camponotus floridanus, and Linepithema humile,
crickets, grasshoppers, locusts (Orthoptera), e.g. Acheta domestica, Gryllotalpa gryllotalpa, Locusta migratoria, Melanoplus bivittatus, Melanoplus femurrubrum, Melanoplus mexicanus, Melanoplus sanguinipes, Melanoplus spretus, Nomadacris septemfasciata, Schistocerca americana, Schistocerca gregaria, Dociostaurus maroccanus, Tachycines asynamorus, Oedaleus senegalensis, Zonozerus variegatus, Hieroglyphus daganensis, Kraussaria angulifera, Calliptamus italicus, Chortoicetes terminifera, Scudderia spp. (katydid) and Locustana pardalina,
Arachnoidea, such as arachnids (Acarina), e.g. of the families Argasidae, Ixodidae and Sarcoptidae, such as Amblyomma americanum, Amblyomma variegatum, Ambryomma maculatum, Argas persicus, Boophilus annulatus, Boophilus decoloratus, Boophilus microplus, Dermacentor silvarum, Dermacentor andersoni, Dermacentor variabilis, Hyalomma truncatum, Ixodes ricinus, Ixodes rubicundus, Ixodes scapularis, Ixodes holocyclus, Ixodes paciflcus, Ornithodorus moubata, Ornithodorus hermsi, Ornithodorus turicata, Ornithonyssus bacoti, Otobius megnini, Dermanyssus gallinae, Psoroptes ovis, Rhipicephalus sanguineus, Rhipicephalus appendiculatus, Rhipicephalus evertsi, Sarcoptes scabiei, and Eriophyidae spp. such as Aculus schlechtendali, Phyllocoptrata oleivora (citrus rust mite), Aceria sheldoni (citrus bud mite) and Eriophyes sheldoni; Tarsonemidae spp. such as Phytonemus pallidus and Polyphagotarsonemus latus; Tenuipalpidae spp. such as Brevipalpus phoenicis; Tetranychidae spp. such as Tetranychus cinnabarinus, Tetranychus kanzawai, Tetranychus paciflcus, Tetranychus telarius and Tetranychus urticae, Panonychus ulmi, Panonychus citri (citrus red mite), and Oligonychus pratensis; Araneida, e.g. Latrodectus mactans, and Loxosceles reclusa,
fleas (Siphonaptera), e.g. Ctenocephalides felis, Ctenocephalides canis, Xenopsylla cheopis, Pulex irritans, Tunga penetrans, and Nosopsyllus fasciatus,
silverfish, firebrat (Thysanura), e.g. Lepisma saccharina and Thermobia domestica, centipedes (Chilopoda), e.g. Scutigera coleoptrata,
millipedes (Diplopoda), e.g. Narceus spp.,
earwigs (Dermaptera), e.g. forficula auricularia,
lice (Phthiraptera), e.g. Pediculus humanus capitis, Pediculus humanus corporis, Pthirus pubis, Haematopinus eurystemus, Haematopinus suis, Linognathus vituli, Bovicola bovis, Menopon gallinae, Menacanthus stramineus and Solenopotes capillatus,
plant parasitic nematodes such as root-knot nematodes, Meloidogyne arenaria, Meloidogyne chitwoodi, Meloidogyne exigua, Meloidogyne hapla, Meloidogyne incognita, Meloidogyne javanica and other Meloidogyne species; cyst nematodes, Globodera rostochiensis, Globodera pallida, Globodera tabacum and other Globodera species, Heterodera avenae, Heterodera glycines, Heterodera schachtii, Heterodera trifolii, and other Heterodera species; seed gall nematodes, Anguina funesta, Anguina tritici and other Anguina species; stem and foliar nematodes, Aphelenchoides besseyi, Aphelenchoides fragariae, Aphelenchoides ritzemabosi and other Aphelenchoides species; sting nematodes, Belonolaimus longicaudatus and other Belonolaimus species; pine nematodes, Bursaphelenchus xylophilus and other Bursaphelenchus species; ring nematodes, Criconema species, Criconemella species, Criconemoides species, and Mesocriconema species; stem and bulb nematodes, Ditylenchus destructor, Ditylenchus dipsaci, Ditylenchus myceliophagus and other Ditylenchus species; awl nematodes, Dolichodorus species; spiral nematodes, Helicotylenchus dihystera, Helicotylenchus multicinctus and other Helicotylenchus species, Rotylenchus robustus and other Rotylenchus species; sheath nematodes, Hemicycliophora species and Hemicriconemoides species; Hirshmanniella species; lance nematodes, Hoplolaimus columbus, Hoplolaimus galeatus and other Hoplolaimus species; false root-knot nematodes, Nacobbus aberrans and other Nacobbus species; needle nematodes, Longidorus elongates and other Longidorus species; pin nematodes, Paratylenchus species; lesion nematodes, Pratylenchus brachyurus, Pratylenchus cofeae, Pratylenchus curvitatus, Pratylenchus goodeyi, Pratylencus neglectus, Pratylenchus penetrans, Pratylenchus scribneri, Pratylenchus vulnus, Pratylenchus zeae and other Pratylenchus species; Radinaphelenchus cocophilus and other Radinaphelenchus species; burrowing nematodes, Radopholus similis and other Radopholus species; reniform nematodes, Rotylenchulus reniformis and other Rotylenchulus species; Scutellonema species; stubby root nematodes, Trichodorus primitivus and other Trichodorus species; Paratrichodorus minor and other Paratrichodorus species; stunt nematodes, Tylenchorhynchus claytoni, Tylenchorhynchus dubius and other Tylenchorhynchus species and Merlinius species; citrus nematodes, Tylenchulus semipenetrans and other Tylenchulus species; dagger nematodes, Xiphinema americanum, Xiphinema index Xiphinema diversicaudatum and other Xiphinema species; and other plant parasitic nematode species.

The combination of the present invention is effective to control the insect pests and mites from the order of Lepidoptera, Coleoptera, Diptera, Isoptera, Acari, Dermaptera, Hymenoptera, Neuroptera, Thysanoptera, Heteroptera, Hemiptera, Dermaptera Parasitiformes, and Plannipennia and Acarina.

The composition of the present invention used to control unwanted insect pests and mites and/or unwanted acarids, is advantageous, for several purposes, e.g.:
useful for addressing a wider range of pest and diseases e.g. insecticidal and acaricidal activity;
offering a single application as a uniform composition in place of separate application of insecticides and acaricide;
offering crop health improvement in comparison to separate applications of insecticides and beneficial species;
longer residual control after application of the composition.

The present invention provides a synergistic combination or composition that shows enhanced action against unwanted insect pests and mites and/or unwanted acarids, in comparison to the control rates that are possible with the individual compounds and/or suitable for improving the health of plants when applied to plants, parts of plants, plant propagation materials, or at their locus.

The synergistic combination or composition of the present invention is particularly important for controlling unwanted insect pests and mites and/or unwanted acarids, on various cultivated plants or plant parts, such as cereals, e.g. wheat, rye, barley, triticale, oats, rice, mushroom; beet, e.g. sugar beet or fodder beet; fruits, such as pomes, stone fruits or soft fruits, e.g. apples, apricot, peanut, pears, pecan, plums, peaches, almonds, cherries, strawberries, raspberries, nectarine, prune, blackberries or gooseberries; leguminous plants, such as lentils, peas, alfalfa or soybeans; oil plants, such as oilseed rape, mustard, olives, sunflowers, coconut, cocoa beans, castor oil plants, oil palms, ground nuts or soybeans; cucurbits, such as squashes, cucumber or melons; fiber plants, such as cotton, flax, hemp or jute; citrus fruit, such as oranges, lemons, grapefruits or mandarins; vegetables, such as spinach, lettuce, asparagus, cabbages, carrots, onions, tomatoes, potatoes, cucurbits or paprika; lauraceous plants, such as avocados, cinnamon or camphor; energy and raw material plants, such as corn, soybean, rape, sugar cane or oil palm; corn; tobacco; nuts; coffee; tea; bananas; vines (table grapes and grape juice grape vines); hop; turf; sweet leaf (also called Stevia); natural rubber plants or ornamental and forestry plants, such as flowers, shrubs, broad-leaved trees or evergreens, e.g. conifers; and on the plant propagation material, such as seeds, and the crop material of these plants.

The composition of the present invention can be applied by any one of the methods selected from atomization, spreading, dusting, spraying, diffusion, immersion, irrigation, injection, mixing, sprinkling (water immersion), foaming, dressing, coating, blasting, fumigation, smoking, smog and painting.

The method of combating pests (insects, acarids or nematodes) depending on the type of compound and the desired effect, the application rates of the mixture according to the invention are from 20 to 1000 g/ha, more preferably from 10 to 750 g/ha, in particular from 20 to 500 g/ha.

The combinations of the present invention provides a method for improving crop health (phyto-tonic effect), comprising treating a plant with an effective amount of composition of flubendiamide and seaweed extracts.

The combinations of the present invention provides a longer residual control of unwanted insect pests and mites and/or unwanted acarids treated with an effective amount of composition of flubendiamide and seaweed extracts.

The present invention is further illustrated by the following examples. These examples describe possible preferred embodiments for illustrative purposes only, but they do not limit the scope of the invention. These laboratory scale experiments can be scaled up to industrial/commercial scale.

### Examples 1-7: Water Dispersible Granules (WDG) Composition

| | | WDG | WDG | WDG | WDG | WDG | WDG | WDG |
|---|---|---|---|---|---|---|---|---|
| | | 01 | 02 | 03 | 04 | 05 | 06 | 07 |
| SN. | Ingredients | % w/w | % w/w | % w/w | % w/w | % w/w | % w/w | % w/w |
| 1 | Flubendiamide Tech. (Purity 96%) | 21.35 | 42.71 | 64.58 | 83.33 | 2.5 | 5 | 5 |
| 2 | Ascophyllum nodosum | 15 | 15 | 5 | 5 | 15 | 20 | 20 |
| 3 | Profenophos Tech. (Purity 96%) | 0 | 0 | 0 | 0 | 0 | 0 | 5 |
| 4 | Sodium Dodecyl Sulphate | 5 | 8 | 8 | 2.67 | 2.5 | 3 | 8 |
| 5 | Ufoxane 30 | 5 | 10 | 6 | 5 | 4 | 6 | 6 |
| 6 | Alphox 215 | 3 | 0 | 0 | 0 | 2 | 2 | 2 |
| 7 | Long Chain Alcohol Ethoxylate | 0 | 0 | 2 | 1 | 2 | 2 | 2 |
| 8 | Lactose | 3 | 0 | 0 | 0 | 0 | 0 | 0 |
| 9 | Polyvinyl Alcohol | 0 | 1 | 1 | 1 | 1 | 1 | 1 |
| 10 | Carboxymethyl Cellulose | 0 | 0 | 1 | 1 | 1 | 1 | 1 |
| 11 | Kaolin Clay | 45 | 21 | 7.42 | 1 | 60 | 50 | 40 |
| 12 | Precipitated silica | 2.65 | 2.29 | 5 | 0 | 10 | 10 | 10 |
| | Total | 100 | 100 | 100 | 100 | 100 | 100 | 100 |

### Examples 8-12: Suspension Concentrate (SC) Composition

| | | SC 01 | SC 02 | SC 03 | SC 04 | SC 05 |
|---|---|---|---|---|---|---|
| SN. | Ingredients | % w/w | % w/w | % w/w | % w/w | % w/w |
| 1 | Flubendiamide Tech. (Purity 96%) | 21.35 | 42.71 | 42.71 | 2.5 | 5 |
| 2 | Ascophyllum nodosum | 5 | 10 | 15 | 15 | 20 |
| 3 | Sodium Dodecyl Sulphate | 3 | 6 | 4 | 3 | 5 |
| 4 | Ufoxane 30 | 6 | 10 | 12 | 10 | 15 |
| 5 | Precipitated silica | 2.65 | 4 | 4 | 4 | 5 |
| 6 | Water | 62 | 27.29 | 22.29 | 65.50 | 50 |
| | Total | 100 | 100 | 100 | 100 | 100 |

### Examples 13-15: Suspo-Emulsion (SE) Composition

| | | SE 01 | SE 02 | SE 03 |
|---|---|---|---|---|
| SN. | Ingredients | % w/w | % w/w | % w/w |
| 1 | Flubendiamide Tech. | 10 | 10 | 5 |
| | (Purity 96%) | | | |
| 2 | Ascophyllum | 5 | 15 | 5 |
| | nodosum | | | |
| 3 | Profenophos Tech. | 10 | 20 | 25 |
| | (Purity 96%) | | | |
| 4 | Sodium Dodecyl | 8 | 10 | 12 |
| | Sulphate | | | |
| 5 | Ufoxane 30 | 6 | 15 | 10 |
| 6 | Precipitated silica | 4 | 4 | 4 |
| 7 | Genepol 80 | 5 | 6 | 6 |
| 8 | Water | 52 | 20 | 33 |
| | Total | 100 | 100 | 100 |

According to the present invention, a synergistic effect exists wherever the action of a combination of active ingredient is greater than the sum of the action of each of the components alone. Therefore a synergistically effective amount or an effective amount of a synergistic composition or combination is an amount that exhibits greater pesticidal activity than the sum of the pesticidal activities of the individual components.

The expected efficacies of active compound combinations may be determined using Colby's formulas (COLBY, S. R. “Calculating synergistic and antagonistic responses of herbicide combination”, Weeds, Vol. 15, pages 20-22; 1967). The action expected for a given combination of two or three active components can be calculated as follows:

Calculation of Two Way Combination for Expected Activity with the Colby Formula:

The expected activity for a given combination of two active compounds (binary composition) can be calculated as follows:

$$E = X + Y - \frac{XY}{100}$$

In which E represents the expected percentage of inhibition of the disease for the combination of two pesticides at defined doses (for example equal to x and y respectively), x is the percentage of inhibition observed for the disease by the compound (1) at a given dose (equal to x), y is the percentage of inhibition observed for the disease by the compound (2) at a defined dose (equal to y).

When the percentage of inhibition observed for the combination is greater than E, there is a synergistic effect.

Calculation of Three Way Combination for Expected Activity with the Colby Formula:

The expected activity for a given combination of three active compounds (ternary composition) can be calculated as follows:

$$E = X + Y + Z - \frac{XY + XZ + YZ}{100} + \frac{XYZ}{10000}$$

X: efficacy, expressed in % of the untreated control, when using the active compound (1) at the concentration a,
Y: efficacy, expressed in % of the untreated control, when using the active compound (2) at the concentration b
Z: efficacy, expressed in % of the untreated control, when using the active compound (3) at the concentration c.
E is the efficacy when the active compounds (1), (2) and (3) are applied at application rates of a, b and c.

### BIOLOGY EXAMPLES

### I] Binary Mixtures:

The experiments were carried out to study synergies if any in terms of the use of insecticide (flubendiamide) and Ascophyllum Nodosum extract mixture at ratio 1:4 and 1:6 for the control of insect pest and phytotonic effect, if any. The insecticidal active compound (flubendiamide as component (I), Ascophyllum Nodosum extract as a component (II) and the mixture thereof were assessed for their activity as described in the following tests: Whole plant Assay/Greenhouse Experiments:

### Example A: Helicoverpa armigera

The whole plant assay was conducted in the greenhouse, in which the desired quantity of the compounds (flubendiamide and Ascophyllum nodosum extract) and mixture in the ratio of 1:4 and 1:6 were prepared. 25 to 30 days old tomato plants were used for the treatments. Prepared compounds (Table 1) were sprayed in the booth of Generation III research sprayer (to obtain uniformity in spray) with a delivery rate of about 500 L/hectare of spray solution through flat fan nozzle. After the treatment, the plants were allowed to dry and then moved to the laboratory. The treated plants were covered with a mylar sheet for restricting the larval movement. Single starved 3rd instar larva was released on to the plants individually and mylar sheet was covered at the top with a muslin cloth for better air ventilation. The observation on dead, moribund and alive larvae was recorded at 72 hours after the treatment. Percent mortality was calculated by combining dead and moribund larvae and comparing the result to the one of the untreated controls.

TABLE 1
Treatment details to evaluate the synergistic effect of the combination
of Flubendiamide and Ascophyllum Nodosum extract

| SN. | Treatment | GAH | Ratio |
|---|---|---|---|
| 1 | Flubendiamide | 30 | |
| 2 | Ascophyllum Nodusum | 120 | |
| 3 | Ascophyllum nodosum | 180 | |
| 4 | Flubendiamide + Ascophyllum nodosum | 30 + 120 | 1:4 |
| 5 | Flubendiamide + Ascophyllum nodosum | 30 + 180 | 1:6 |
| 6 | Control | NA | NA |

### Example B: Spodoptera litura

The whole plant assay was conducted in the greenhouse, in which the desired quantity of the compounds (flubendiamide and Ascophyllum nodosum extract) and mixture in the ratio of 1:4 and 1:6 were prepared. 25 to 30 days old tomato plants were used for the treatments. Prepared compounds (Table 1) were sprayed in the booth of Generation III research sprayer (to obtain uniformity in spray) with a delivery rate of about 500 L/hectare of spray solution through flat fan nozzle. After the treatment, the plants were allowed to dry and then moved to the laboratory. The treated plants were covered with a mylar sheet for restricting the larval movement. Single starved 3rd instar larva was released on to the plants individually and mylar was covered at the top with a muslin cloth for better air ventilation. The observation on dead, moribund and alive larvae was recorded at 72 hours after the treatment. Percent mortality was calculated by combining dead and moribund larvae and comparing the result to the one of the untreated controls.

### Field Studies:

The Field experiment was conducted at PI Industries Limited, Agricultural Research Station, Hyderabad to evaluate the efficacy of mixture of flubendiamide and Ascophyllum nodosum against Spodoptera litura in tomato crop. The tomato seedlings were transplanted and all the recommended package of practices for tomato farming was followed in the experiment, except for plant protection chemicals. The ratio of flubendiamide and Ascophyllum nodosum mixture was 1:4 & 1:6 and the experiment was carried out in plots of 5×5 m in a randomized block design with three replications for each treatment. The applications were done with the help of a knapsack sprayer having a delivery of about 500 L/hectare. Care was taken to avoid drift of spray solution to adjacent experimental plots. Assessment of all the treatments was done for vigor, phytotoxicity and insect control. Observation on the insect larval count per plot from fifteen randomly selected plants was recorded at one day before and on 7 and 10 Day after application. Later percent control was calculated by comparing the result with the untreated controls. Vigor descriptive scale was totally based on visual observations. For vigor comparison among treatments, untreated plots were considered as 100 percent and based on that rating was given to other treatments.

### Establishment of Synergistic Action:

Surprisingly, the present experimental trial established evidence of a synergistic effect of the combination of flubendiamide and Ascophyllum nodosum; showing effective control against rice stem borer, sheath blight and leaf blast when compared with their solo applications.

### Results

Efficacy of Flubendiamide and Ascophyllum nodosum Extract Mixture Against Helicoverpa armigera in Greenhouse Condition

The results of bioassay on Helicoverpa armigera under laboratory conditions are presented in Table 2. 70 percent mortality was recorded after 72 hours release of Helicoverpa armigera larvae on treated leaves of flubendiamide applied at 30 GAH.

TABLE 2
Efficacy of flubendiamide and Ascophyllum nodosum extract mixture
against Helicoverpa armigera in greenhouse condition

| | | | | % |
|---|---|---|---|---|
| SN. | Treatment | GAH | Ratio | mortality |
| 1 | Flubendiamide | 30 | | 70 |
| 2 | Ascophyllum nodosum | 120 | | 0 |
| 3 | Ascophyllum nodosum | 180 | | 0 |
| 4 | Flubendiamide + Ascophyllum nodosum | 30 + 120 | 1:4 | 70 |
| 5 | Flubendiamide + Ascophyllum nodosum | 30 + 180 | 1:6 | 75 |
| 6 | Control | NA | NA | 0 |

Efficacy of Flubendiamide and Ascophyllum nodosum Extract Mixture Against Spodoptera litura in Greenhouse Condition

The results of bioassay on Spodoptera litura under laboratory conditions are presented in Table 3. 70 percent mortality was recorded after 72 hours release of Spodoptera litura larvae on treated leaves of flubendiamide applied at 30 GAH.

TABLE 3
Efficacy of flubendiamide and Ascophyllum nodosum extract mixture
against Spodoptera litura in greenhouse condition

| | | | | % |
|---|---|---|---|---|
| SN. | Treatment | GAH | Ratio | mortality |
| 1 | Flubendiamide | 30 | | 70 |
| 2 | Ascophyllum nodosum | 120 | | 0 |
| 3 | Ascophyllum nodosum | 180 | | 0 |
| 4 | Flubendiamide + Ascophyllum nodosum | 30 + 120 | 1:4 | 70 |
| 5 | Flubendiamide + Ascophyllum nodosum | 30 + 180 | 1:6 | 70 |
| 6 | Control | NA | NA | 0 |

Efficacy of Flubendiamide and Ascophyllum nodosum Extract Mixture Against Spodoptera litura in Field Condition

Field experiment on efficacy of flubendiaide, an insecticide of phthalic acid diamides group, at 30 GAH against Spodoptera litura in tomato effectively controlled the insect pests.

TABLE 4
Efficacy of flubendiamide and Ascophyllum nodosum extract
mixture against Spodoptera litura in field condition

| | | | | Spodoptera litura | |
|---|---|---|---|---|---|
| | | | | (% control) | |
| SN. | Treatment | GAH | Ratio | 7 DAA | 10 DAA |
| 1 | Flubendiamide | 30 | | 66.67 | 70.00 |
| 2 | Ascophyllum nodosum | 120 | | 0 | 0 |
| 3 | Ascophyllum nodosum | 180 | | 0 | 0 |
| 4 | Flubendiamide + Ascophyllum nodosum | 30 + 120 | 1:4 | 68.75 | 71.88 |
| 5 | Flubendiamide + Ascophyllum nodosum | 30 + 180 | 1:6 | 71.43 | 74.29 |
| 6 | Control | NA | NA | 0 | 0 |

### Vigor

Visual observation of the combination clearly indicated that both active ingredients were physically compatible and safe to the crop. No Phytotoxicity symptoms were observed in any of the treatments. Flubendiamide, Ascophyllum Nodosum as solo and in combination showed good plant vigor when compared with control. Phiytotonic effect in terms of vigour was observed in the combination of flubendiamide+Ascophyllum nodosum.

TABLE 5
Vigor Rating

| | | | | | | Differ- |
|---|---|---|---|---|---|---|
| SN. | Treatment | GAH | Ratio | Vigor | Expected | ence |
| 1 | Flubendiamide | 30 | | 110 | | 0.00 |
| 2 | Ascophyllum | 120 | | 105 | | 0.00 |
| | nodosum | | | | | |
| 3 | Ascophyllum | 180 | | 105 | | 0.00 |
| | nodosum | | | | | |
| 4 | Flubendiamide + | 30 + 120 | 1:4 | 115 | 99.5 | +15.50 |
| | Ascophyllum | | | | | |
| | nodosum | | | | | |
| 5 | Flubendiamide + | 30 + 180 | 1:6 | 120 | 99.5 | +20.50 |
| | Ascophyllum | | | | | |
| | nodosum | | | | | |
| 6 | Control | NA | NA | 100 | | 0.00 |

Differences between observed and expected values are shown by a plus (+) sign to indicate synergism

### Yield of Tomato Fruits

Significantly high (80.73 t/ha) frit yield obtained when crop was treated with flubendiaiede+Ascophyllum nodosum @ 30+180 GAH.

TABLE 6
Yield of tomato fruits

| | | | | Ton/ha | Expected | |
|---|---|---|---|---|---|---|
| SN. | Treatment | GAH | Ratio | (observed) | (Colby equation) | Difference |
| 1 | Flubendiamide | 30 | | 60.16 | | |
| 2 | Ascophyllum nodosum | 120 | | 43.36 | | |
| 3 | Ascophyllum nodosum | 180 | | 51.64 | | |
| 4 | Flubendiamide + Ascophyllum nodosum | 30 + 120 | 1:4 | 77.6 | 77.43 | +0.17 |
| 5 | Flubendiamide + Ascophyllum nodosum | 30 + 180 | 1:6 | 83.64 | 80.73 | +2.91 |
| 6 | Control | NA | NA | 40.24 | | |

Differences between observed and expected values are shown by a plus (+) sign to indicate synergism

### Conclusion

Surprising synergies were seen in terms of crop vigor. Test combination of Flubendiamide+Ascophyllum Nodosum at 30+120 GAH and 30+180 GAH indicated synergies in terms enhanced plant growth and yield along with increased pest control.

### II] 3-Way Mixtures:

The experiments were carried out to study synergies if any in terms of the use of insecticides (Flubendiamide & Profenofos) and Ascophyllum Nodosum extract mixture at ratio 1:16:4 and 1:16:6 for the control of insect pest and phytotonic effect, if any. The insecticidal active compounds includes Flubendiamide as component (I), Profenofos as component (II), Ascophyllum Nodosum extract as component (III) and the mixture thereof were assessed for their activity as described in the following tests:

### Example C: Helicoverpa armigera

The whole plant assay was conducted in the greenhouse, in which the desired quantity of the compounds (Flubendiamide, Profenofos and Ascophyllum Nodosum extract) and mixture in the ratio of 1:16:4 and 1:16:6 were prepared. 40-45 days old tomato plants were used for the treatments. Prepared compounds (Table 7) were sprayed in the booth of Generation III research sprayer (to obtain uniformity in spray) with a delivery rate of about 500 L/hectare of spray solution through flat fan nozzle. After the treatment, the plants were allowed to dry and then moved to the laboratory. The treated plants were covered with a mylar sheet for restricting the larval movement. Single starved 3rd instar larva was released on to the plants individually and mylar sheet was covered at the top with a muslin cloth for better air ventilation. The observation on dead, moribund and alive larvae was recorded at 72 hours after the treatment. Percent mortality was calculated by combining dead and moribund larvae and comparing the result to the one of the untreated controls.

TABLE 7
Treatment details to evaluate the synergistic effect of the combination
of Flubendiamide, Profenofos and Ascophyllum Nodosum extract

| SN. | Treatment | GAH | Ratio |
|---|---|---|---|
| 1 | Flubendiamide | 30 | |
| 2 | Profenofos | 480 | |
| 3 | Ascophyllum Nodosum | 120 | |
| 4 | Ascophyllum Nodosum | 180 | |
| 5 | Flubendiamide + Profenofos | 30 + 480 | 1:16 |
| 6 | Flubendiamide + Ascophyllum Nodosum | 30 + 120 | 1:4 |
| 7 | Flubendiamide + Ascophyllum Nodosum | 30 + 180 | 1:6 |
| 8 | Profenofos + Ascophyllum Nodosum | 480:120 | 4:1 |
| 9 | Profenofos + Ascophyllum Nodosum | 480:180 | 4:2.7 |
| 10 | Flubendiamide + Profenofos + Ascophyllum Nodosum | 30 + 480 + 120 | 1:16:4 |
| 11 | Flubendiamide + Profenofos + Ascophyllum Nodosum | 30 ++ 480 + 180 | 1:16:6 |
| 12 | Control | NA | NA |

### Example D: Spodoptera litura

The whole plant assay was conducted in the greenhouse, in which the desired quantity of the compounds (Flubendiamide, Profenofos and Ascophyllum Nodosum extract) and mixture in the ratio of 1:16:4 and 1:16:6 were prepared. 40-45 days old tomato plants were used for the treatments. Prepared compounds (Table 7) were sprayed in the booth of Generation III research sprayer (to obtain uniformity in spray) with a delivery rate of about 500 L/hectare of spray solution through flat fan nozzle. After the treatment, the plants were allowed to dry and then moved to the laboratory. The treated plants were covered with a mylar sheet for restricting the larval movement. Single starved 3rd instar larva was released on to the plants individually and mylar was covered at the top with a muslin cloth for better air ventilation. The observation on dead, moribund and alive larvae was recorded at 72 hours after the treatment. Percent mortality was calculated by combining dead and moribund larvae and comparing the result to the one of the untreated controls.

### Example E: Thrips

The whole plant assay was conducted in the greenhouse, in which the desired quantity of the compounds (Flubendiamide, Profenofos and Ascophyllum Nodosum extract) and mixture in the ratio of 1:16:4 and 1:16:6 were prepared. 40-45 days old brinjal plants were used for the treatments. Prepared compounds (Table 7) were sprayed in the booth of Generation III research sprayer (to obtain uniformity in spray) with a delivery rate of about 500 L/hectare of spray solution through flat fan nozzle. After the treatment, the plants were allowed to dry and then moved to the laboratory. The treated plants were covered with a mylar sheet for restricting the larval movement. Nymph of thrips was released on to the plants individually and mylar was covered at the top with a muslin cloth for better air ventilation. The observation on dead, moribund and alive larvae was recorded at 72 hours after the treatment. Percent mortality was calculated by combining dead and moribund larvae and comparing the result to the one of the untreated controls.

### Field Studies

The Field experiment was conducted at PI Industries Limited, Agricultural Research Station, Hyderabad to evaluate the efficacy of mixture of Flubendiamide, Profenofos and Ascophyllum Nodosum against Spodoptera litura in tomato crop. The tomato seedlings were transplanted and all the recommended packages of practices for tomato farming were followed in the experiment, except for plant protection chemicals. The ratio of Flubendiamide, Profenofos and Ascophyllum Nodosum mixture was 1:16:4 and 1:16:6 and the experiment was carried out in plots of 5×5 m in a randomized block design with three replications for each treatment. The applications were done with the help of a knapsack sprayer having a delivery of about 500 L/hectare. Care was taken to avoid drift of spray solution to adjacent experimental plots. Assessment of all the treatments was done for vigor, phytotoxicity and insect control. Observation on the insect larval count per plot from fifteen randomly selected plants was recorded at one day before and on 7 Day after application. Later percent control was calculated by comparing the result with the untreated controls. Vigor descriptive scale was totally based on visual observations. For vigor comparison among treatments, untreated plots were considered as 100 percent and based on that rating was given to other treatments.

### Establishment of Synergistic Action:

Surprisingly, the present experimental trial established evidence of a synergistic effect of the combination of flubendiamide, profenofos and Ascophyllum nodosum; showing effective control against rice stem borer, sheath blight and leaf blast when compared with their solo applications or 2-way mixtures.

### Results:

Efficacy of Flubendamide, Profenofos and Ascophyllum Nodosum Extract Mixture Against Helicoverpa armigera in Greenhouse Condition

The results of bioassay on Helicoverpa armigera under laboratory conditions are presented in Table 8. 90 percent mortality was recorded after 72 hours release of Helicoverpa armigera larvae on treated leaves of flubendiamide Profenofos and Ascophyllum Nodosum extract mixture at 1:16:6 ratio.

TABLE 8
Efficacy of Flubendiamide, Profenofos and Ascophyllum Nodosum extract
mixture against Helicoverpa armigera in greenhouse condition

| | | | | | Expected | |
|---|---|---|---|---|---|---|
| | | | | | mortality | |
| | | | | Observed % | (Colby's | |
| SN. | Treatment | GAH | Ratio | mortality | Equation) | Synergy |
| 1 | Flubendiamide | 30 | | 65 | | |
| 2 | Profenofos | 480 | | 50 | | |
| 3 | Ascophyllum Nodosum | 120 | | 5 | | |
| 4 | Ascophyllum Nodosum | 180 | | 5 | | |
| 5 | Flubendiamide + Profenofos | 30 + 480 | 1:16 | 85 | 82.50 | +2.50 |
| 6 | Flubendiamide + Ascophyllum Nodosum | 30 + 180 | 1:6 | 70 | 66.75 | +3.25 |
| 7 | Profenofos + Ascophyllum Nodosum | 480:120 | 4:1 | 55 | 52.50 | +2.50 |
| 8 | Profenofos + Ascophyllum Nodosum | 480:180 | 4:2.7 | 55 | 52.50 | +2.50 |
| 9 | Flubendiamide + Profenofos + Ascophyllum Nodosum | 30 + 480 + 120 | 1:16:4 | 85 | 81.87 | +3.13 |
| 10 | Flubendiamide + Profenofos + Ascophyllum Nodosum | 30 + 480 + 180 | 1:16:6 | 90 | 81.87 | +8.13 |
| | Control | NA | NA | 0 | | |

Differences between observed and expected values are shown by a plus (+) sign to indicate synergism

Efficacy of Flubendiamide, Profenofos and Ascophyllum Nodosum Extract Mixture Against Spodoptera litura in Greenhouse Condition

The results of bioassay on Spodoptera litura under laboratory conditions are presented in Table 9.92 percent mortality was recorded after 72 hours release of Spodoptera litura larvae on treated leaves of flubendiamide Profenofos and Ascophyllum Nodosum extract mixture at 1:16:6 ratio.

TABLE 9
Efficacy of Flubendiamide, Profenofos and Ascophyllum Nodosum extract
mixture against Spodoptera litura in greenhouse condition

| | | | | | Expected | |
|---|---|---|---|---|---|---|
| | | | | | mortality | |
| | | | | Observed % | (Colby's | |
| SN. | Treatment | GAH | Ratio | mortality | Equation) | Synergy |
| 1 | Flubendiamide | 30 | | 72 | | |
| 2 | Profenofos | 480 | | 52 | | |
| 3 | Ascophyllum Nodosum | 120 | | 0 | | |
| 4 | Ascophyllum Nodosum | 180 | | 0 | | |
| 5 | Flubendiamide + Profenofos | 30 + 480 | 1:16 | 88 | 86.56 | +1.44 |
| 6 | Flubendiamide + Ascophyllum Nodosum | 30 + 120 | 1:4 | 72 | 72.00 | 0.00 |
| 7 | Flubendiamide + Ascophyllum Nodosum | 30 + 180 | 1:6 | 76 | 72.00 | +4.00 |
| 8 | Profenofos + Ascophyllum Nodosum | 480:120 | 4:1 | 56 | 52.00 | +4.00 |
| 9 | Profenofos + Ascophyllum Nodosum | 480:180 | 4:2.7 | 56 | 52.00 | +4.00 |
| 10 | Flubendiamide + Profenofos + Ascophyllum Nodosum | 30 + 480 + 120 | 1:16:4 | 88 | 87.00 | +1.32 |
| 11 | Flubendiamide + Profenofos + Ascophyllum Nodosum | 30 + 480 + 180 | 1:16:6 | 92 | 87.00 | +5.32 |
| 12 | Control | NA | NA | 0 | | |

Differences between observed and expected values are shown by a plus (+) sign to indicate synergism

### Efficacy of Flubendiamide, Profenofos and Ascophyllum Nodosum Extract Mixture Against Thrips in Greenhouse Condition

The results of bioassay on thrips under laboratory conditions are presented in Table 10. 84 percent mortality was recorded after 72 hours release of thrips nymph on treated leaves of Flubendiamide, Profenofos and Ascophyllum Nodosum extract mixture at 1:16:6 ratio.

TABLE 10
Efficacy of Flubendiamide, Profenofos and Ascophyllum Nodosum
extract mixture against Thrips in greenhouse condition

| | | | | | Expected | |
|---|---|---|---|---|---|---|
| | | | | | mortality | |
| | | | | Observed % | (Colby's | |
| SN. | Treatment | GAH | Ratio | mortality | Equation) | Synergy |
| 1 | Flubendiamide | 30 | | 8 | | |
| 2 | Profenofos | 480 | | 72 | | |
| 3 | Ascophyllum Nodosum | 120 | | 0 | | |
| 4 | Ascophyllum Nodosum | 180 | | 4 | | |
| 5 | Flubendiamide + Profenofos | 30 + 480 | 1:16 | 76 | 74 | +1.76 |
| 6 | Flubendiamide + Ascophyllum Nodosum | 30 + 120 | 1:4 | 12 | 8 | +4.00 |
| 7 | Flubendiamide + Ascophyllum Nodosum | 30 + 180 | 1:6 | 12 | 12 | +0.32 |
| 8 | Profenofos + Ascophyllum Nodosum | 480:120 | 4:1 | 72 | 72 | 0.00 |
| 9 | Profenofos + Ascophyllum Nodosum | 480:180 | 4:2.7 | 76 | 73 | +2.88 |
| 10 | Flubendiamide + Profenofos + Ascophyllum Nodosum | 30 + 480 + 120 | 1:16:4 | 80 | 74 | +5.68 |
| 11 | Flubendiamide + Profenofos + Ascophyllum Nodosum | 30 + 480 + 180 | 1:16:6 | 84 | 75 | +8.88 |
| 12 | Control | NA | NA | 0 | | |

Differences between observed and expected values are shown by a plus (+) sign to indicate synergism

Efficacy of Flubendiamide, Profenofos and Ascophyllum Nodosum Extract Mixture Against Spodoptera litura in Field Condition

Synergistic interactions were observed for the mixture comprising of Flubendiamide, Profenofos and Ascophyllum Nodosum extract at ratios 1:16:4 and 1:16:6. At both mixture ratios insect mortality was 88.6 and 92.1 percent and the difference between observed value and the expected value is in plus (+) figures i.e. +1.4 and +4.1 respectively show the synergistic action of combination (Table 11).

TABLE 11
Efficacy of Flubendiamide, Profenofos and Ascophyllum Nodosum
extract mixture against Spodoptera litura in field condition

| | | | | | Expected | |
|---|---|---|---|---|---|---|
| | | | | | mortality | |
| | | | | Observed % | (Colby's | |
| SN. | Treatment | GAH | Ratio | mortality | Equation) | Synergy |
| 1 | Flubendiamide | 30 | | 72.7 | | |
| 2 | Profenofos | 480 | | 55.6 | | |
| 3 | Ascophyllum Nodosum | 120 | | 2.9 | | |
| 4 | Ascophyllum Nodosum | 180 | | 0.0 | | |
| 5 | Flubendiamide + Profenofos | 30 + 480 | 1:16 | 90.6 | 87.9 | +2.7 |
| 6 | Profenofos + Ascophyllum Nodosum | 480:180 | 4:2.7 | 56.7 | 55.6 | +1.1 |
| 7 | Flubendiamide + Profenofos + Ascophyllum Nodosum | 30 + 480 + 120 | 1:16:4 | 88.6 | 87.2 | +1.4 |
| 8 | Flubendiamide + Profenofos + Ascophyllum Nodosum | 30 + 480 + 180 | 1:16:6 | 92.1 | 88.0 | +4.1 |
| | Control | NA | NA | 0.0 | | |

Differences between observed and expected values are shown by a plus (+) sign to indicate synergism

### Vigor

Visual observation of the combination clearly indicated that both active ingredients were physically compatible and safe to the crop. No Phytotoxicity symptoms were observed in any of the treatments. Flubendiamide, Profenofos and Ascophyllum Nodosum as solo and in combination showed good plant vigor when compared with control. Very good Phiytotonic effect in terms of vigour was observed in the combination of Flubendiamide+Profenofos+Ascophyllum Nodosum at ratio 1:16:6.

TABLE 12
Vigor Rating

| SN. | Treatment | GAH | Ratio | Vigor rating |
|---|---|---|---|---|
| 1 | Flubendiamide | 30 | | 125 |
| 2 | Profenofos | 480 | | 120 |
| 3 | Ascophyllum Nodosum | 120 | | 110 |
| 4 | Ascophyllum Nodosum | 180 | | 110 |
| 5 | Flubendiamide + | 30 + 480 | 1:16 | 125 |
| | Profenofos | | | |
| 6 | Flubendiamide + | 30 + 120 | 1:4 | 135 |
| | Ascophyllum Nodosum | | | |
| 7 | Flubendiamide + | 30 + 180 | 1:6 | 135 |
| | Ascophyllum Nodosum | | | |
| 8 | Profenofos + | 480:120 | 4:1 | 130 |
| | Ascophyllum Nodosum | | | |
| 9 | Profenofos + | 480:180 | 4:2.7 | 135 |
| | Ascophyllum Nodosum | | | |
| 10 | Flubendiamide + | 30 + 480 + 120 | 1:16:4 | 160 |
| | Profenofos + | | | |
| | Ascophyllum Nodosum | | | |
| 11 | Flubendiamide + | 30 ++ 480 + 180 | 1:16:6 | 170 |
| | Profenofos + | | | |
| | Ascophyllum Nodosum | | | |
| 12 | Control | NA | NA | 100 |

### Yield of Tomato Fruits

Significantly highest (88.68 t/ha) fruit yield obtained when crop was treated with Flubendiamide+Profenofos+Ascophyllum Nodosum at 30+480+180 GAH.

TABLE 13
Yield of tomato fruits

| | | | | Observed yield | Expected | |
|---|---|---|---|---|---|---|
| SN. | Treatment | GAH | Ratio | (ton/hectare) | yield | Synergy |
| 1 | Flubendiamide | 30 | | 64.20 | | |
| 2 | Profenofos | 480 | | 56.95 | | |
| 3 | Ascophyllum Nodosum | 120 | | 47.70 | | |
| 4 | Ascophyllum Nodosum | 180 | | 51.06 | | |
| 5 | Flubendiamide + Ascophyllum Nodosum | 30 + 120 | 1:4 | 81.76 | 81 | +0.48 |
| 6 | Flubendiamide + Ascophyllum Nodosum | 30 + 180 | 1:6 | 83.64 | 82 | +1.16 |
| 7 | Profenofos + Ascophyllum Nodosum | 480:120 | 4:1 | 79.84 | 77 | +2.36 |
| 8 | Profenofos + Ascophyllum Nodosum | 480:180 | 4:2.7 | 80.72 | 79 | +1.79 |
| 9 | Flubendiamide + Profenofos + Ascophyllum Nodosum | 30 + 480 + 120 | 1:16:4 | 87.80 | 75 | +13.13 |
| 10 | Flubendiamide + Profenofos + Ascophyllum Nodosum | 30 + 480 + 180 | 1:16:6 | 88.68 | 74 | +14.71 |
| | Control | NA | NA | 40.24 | | |

Difference between observed and expected values are shown by a plus (+) sign to indicate synergism

### Conclusion

Surprising synergies were seen in terms of fruit yield and insect control. Test combination of Flubendiamide+Profenofos+Ascophyllum Nodosum at 30+480+120 GAH and 30+480+180 GAH indicated in terms enhanced plant growth and synergies in yield along with increased pest control.

Thus, from the foregoing description, it will be apparent to a person skilled in the art that many changes and modifications can be made thereto without departing from the spirit or scope of the invention as set forth in the description.

Accordingly, it is not intended that the scope of the foregoing description is limited to the description set forth above, but rather that such description be construed as encompassing such features that reside in the present invention, including all the features and embodiments that would be treated as equivalents thereof by those skilled in the relevant art.

1. A combination comprising:
a) flubendiamide or acceptable salt(s) thereof; and
b) at least one seaweed extract.

2. The combination as claimed in claim 1, wherein said seaweed extract comprises Ascophyllum nodosum, Sargassum spp., Fucus spp., Fucus vesiculosus, Laminaria spp., Laminaria digitata, Laminaria hyperborea, Laminaria saccharina, Eklonia spp., Eklonia maxima, and Turbinaria spp. or mixture thereof.

3. The combination as claimed in claim 1, wherein the ratio of flubendiamide and seaweed extract is from 1:100 to 100:1.

4. The combination as claimed in claim 1, wherein said combination optionally comprises at least one additional active agent selected from insecticides, fungicides, acaricides, nematicides, herbicides or acceptable salt(s), or mixtures thereof.

5. The combination as claimed in claim 4, wherein said insecticide is selected from the group consisting of
(I-A) acetylcholinesterase (AChE) inhibitors, selected from the class of
(I-A1) carbamates: (I-A1001) alanycarb, (I-A1002) aldicarb, (I-A1003) bendiocarb, (I-A1004) benfuracarb, (I-A1005) butocarboxim, (I-A1006) butoxycarboxim, (I-A1007) carbaryl, (I-A1008) carbofuran, (I-A1009) carbosulfan, (I-A1010) ethiofencarb, (I-A1011) fenobucarb, (I-A1012) formetanate, (I-A1013) furathiocarb, (I-A1014) isoprocarb, (I-A1015) methiocarb, (I-A1016) methomyl, (I-A1017) metolcarb, (I-A1018) oxamyl, (I-A1019) pirimicarb, (I-A1020) propoxur, (I-A1021) thiodicarb, (l-A1022) thiofanox, (I-A1023) triazamate, (I-A1024) trimethacarb, (I-A1025) 3,5-Xylyl methylcarbamate (XMC), (I-A1026) xylylcarb;
(I-A2) organophosphates: (I-A2001) acephate, (I-A2002) azamethiphos, (I-A2003) azinphos-ethyl, (I-A2004) azinphosmethyl, (I-A2005) cadusafos, (I-A2006) chlorethoxyfos, (I-A2007) chlorfenvinphos, (I-A2008) chlormephos, (I-A2009) chlorpyrifos, (I-A2010) chlorpyrifos-methyl, (I-A2011) coumaphos, (I-A2012) cyanophos, (I-A2013) demeton-s-methyl, (I-A2014) diazinon, (I-A2015) dichlorvos/ddvp, (I-A2016) dicrotophos, (I-A2017) dimethoate, (l-A2018) dimethylvinphos, (l-A2019) disulfoton, (l-A2020) EPN, (I-A2021) ethion, (I-A2022) ethoprophos, (I-A2023) famphur, (I-A2024) fenamiphos, (I-A2025) fenitrothion, (I-A2026) fenthion, (I-A2027) fosthiazate, (I-A2028) heptenophos, (I-A2029) imicyafos, (I-A2030) isofenphos, (I-A2031) isopropyl o-(methoxyaminothio-phosphoryl) salicylate, (I-A2032) isoxathion, (I-A2033) malathion, (I-A2034) mecarbam, (I-A2035) methamidophos, (I-A2036) methidathion, (I-A2037) mevinphos, (l-A2038) monocrotophos, (l-A2039) naled, (I-A2040) omethoate, (I-A2041) oxydemeton-methyl, (I-A2042) parathion, (I-A2043) parathion-methyl, (I-A2044) phenthoate, (I-A2045) phorate, (l-A2046) phosalone, (I-A2047) phosmet, (l-A2048) phosphamidon, (I-A2049) phoxim, (I-A2050) pirimiphos-methyl, (I-A2051) profenofos, (I-A2052) propetamphos, (I-A2053) prothiofos, (I-A2054) pyraclofos, (I-A2055) pyridaphenthion, (I-A2056) quinalphos, (I-A2057) sulfotep, (I-A2058) tebupirimfos, (I-A2059) temephos, (I-A2060) terbufos, (I-A2061) tetrachlorvinphos, (I-A2062) thiometon, (l-A2063) triazophos, (I-A2064) trichlorfon, (I-A2065) vamidothion;
(I-C) sodium channel modulators, selected from the class of
(I-C1) pyrethroids/pyrethrins: (I-C1001) acrinathrin, (I-C1002) allethrin, (I-C1003) d-cis-trans allethrin, (I-C1004) d-trans-allethrin, (I-C1005) bifenthrin, (I-C1006) bioallethrin, (I-C1007) bioallethrin s-cyclopentenyl isomer, (I-C1008) bioresmethrin, (I-C1009) cycloprothrin, (I-C1010) cyfluthrin, (I-C1011) beta-cyfluthrin, (I-C1012) cyhalothrin, (I-C1013) lambda-cyhalothrin, (I-C1014) gamma-cyhalothrin, (I-C1015) cypermethrin, (I-C1016) alpha-cypermethrin, (I-C1017) beta-cypermethrin, (I-C1018) theta-cypermethrin, (I-C1019) zeta-cypermethrin, (I-C1020) cyphenothrin, (I-C1021) (1R)-trans-cyphenothrin, (I-C1022) deltamethrin, (I-C1023) empenthrin (EZ)-(1R)-isomers], (I-C1024) esfenvalerate, (I-C1025) etofenprox, (I-C1026) fenpropathrin, (I-C1027) fenvalerate, (I-C1028) flucythrinate, (I-C1029) flumethrin, (I-C1030) tau-fluvalinate, (I-C1031) halfenprox, (I-C1032) imiprothrin, (I-C1033) meperfluthrin, (I-C1034) metofluthrin, (I-C1035) momfluorothrin, (I-C1036) kadethrin, (I-C1037) permethrin, (I-C1038) phenothrin [(1R)-trans-isomer], (I-C1039) prallethrin, (I-C1040) profluthrin, (I-C1041) pyrethrins (pyrethrum), (I-C1042) resmethrin, (I-C1043) silafluofen, (I-C1044) tefluthrin, (I-C1045) tetramethylfluthrin, (I-C1046) tetramethrin, (I-C1047) tetramethrin [(1R)-isomers], (I-C1048) tralomethrin, (I-C1049) transfluthrin;
(I-C2) organochlorine: (I-C2001) DDT, (I-C2002) methoxychlor;
(I-D) nicotinic acetylcholine receptor (nAChR) competitive modulators, selected from the class of
(I-D1) neonicotinoids: (I-D1001) acetamiprid, (I-D1002) clothianidin, (I-D1003) dinotefuran, (I-D1004) imidacloprid, (I-D1005) nitenpyram, (I-D1006) thiacloprid, (I-D1007) thiamethoxam;
(I-P) inhibitors of the chitin biosynthesis type 1: (I-P1001) buprofezin;
(I-Z) ryanodine receptor modulators, selected from the class of
(I-Z1) diamides: (I-Z1001) tetra-chlorantraniliprole, (I-Z1002) chlorantraniliprole, (I-Z1003) cyantraniliprole, (I-Z1004) cyclaniliprole, (I-Z1005) tetraniliprole.

6. The combination as claimed in claim 4, wherein said fungicide is selected from the group consisting of:
(II-A) inhibitors of the sterol biosynthesis: (II-A001) cyproconazole, (II-A002) difenoconazole, (II-A003) epoxiconazole, (II-A004) fenhexamid, (II-A005) fenpropidin, (II-A006) fenpropimorph, (II-A007) fenpyrazamine, (II-A008) fluquinconazole, (II-A009) flutriafol, (II-A010) imazalil, (II-A011) imazalil sulfate, (II-A012) ipconazole, (II-A013) metconazole, (II-A014) myclobutanil, (II-A015) paclobutrazol, (II-A016) prochloraz, (II-A017) propiconazole, (II-A018) prothioconazole, (II-A019) pyrisoxazole, (II-A020) spiroxamine, (II-A021) tebuconazole, (II-A022) tetraconazole, (II-A023) triadimenol, (II-A024) tridemorph, (II-A025) triticonazole, (II-A026) mefentrifluconazole, (II-A027) ipfentrifluconazole, II-A028) terbinafine, (II-A029) buthiobate, (II-A030) pyrifenox, (II-A031) fenarimol, (II-A032) nuarimol, (II-A033) triarimol, (II-A034) triforine, (II-A035) clotrimazole, (II-A036) econazole, (II-A037) isoconazole, (II-A038) miconazole, (1l-A039) oxpoconazole, (II-A040) pefurazoate, (II-A041) triflumizole, (II-A042) azaconazole, (II-A043) bitertanol, (II-A044) bromuconazole, (II-A045) diniconazole, (II-A046) diniconazole-M, (II-A047) etaconazole, (II-A048) fenbuconazole, (II-A049) hexaconazole, (II-A050) imibenconazole, (II-A051) penconazole, (II-A052) simeconazole, (II-A053) triadimefon, (II-A054) uniconazole, (II-A055) pyributicarb, (II-A056) dodemorph, (II-A057) aldimorph, (II-A058) trimorphamide, (II-A059) piperalin, (II-A060) naftifine.

7. The combination as claimed in claim 1, wherein the particle size of the active ingredient(s) is in the range of 1 to 80 μm.

8. A composition comprising a combination as claimed in claim 1, and agriculturally acceptable additive(s).

9. The composition as claimed in claim 8, wherein agriculturally acceptable additives are selected from solid carrier(s), liquid carrier(s), gaseous carrier(s), surfactant(s), emulsifier(s), binder(s), disintegrating agent(s), pH adjuster(s), thickener(s), preservative(s), anti-caking agent(s), anti-freezing agent(s), defoaming agent(s), extender(s), stabilizer(s) and/or coloring agent(s) or mixtures thereof.

10. The composition as claimed in claim 8, wherein said composition is in the form of a wettable powder (WP), a water dispersible granule (WG), a water dispersible tablet (WT), granule (GR), an emulsifiable granule (EG), a water soluble powder (SP), an ultra-low volume (ULV) liquid (UL), an ultra-low volume (ULV) suspension (SU), a soluble concentrate (SL), a water soluble granule (SG), a suspo-emulsion (SE), an oil-in-water emulsion (EW), an emulsifiable concentrate (EC), a micro-emulsion (ME), an oil dispersion (OD), a capsule suspension (CS), an aerosol (AE), a mixed formulation of CS and SE (ZE), a mixed formulation of CS and SW (ZW) or a mixed formulation of CS and SC (ZC).

11. The composition as claimed in claim 10, wherein said composition is in the form of suspension concentrate (SC), suspo-emulsion (SE), oil-in-water emulsions (EW), emulsion concentrate (EC), wettable powder (WP) or a water dispersible granule (WDG).

12. A method for the preparation of composition as claimed in claim 8, comprising the steps of:
a) adding flubendiamide or acceptable salt(s) thereof; at least one seaweed extract, and optionally insecticidal or fungicidal or acaricidal or nematicidal or herbicidal compounds or acceptable salt(s) and mixtures thereof; and
b) adding agrochemically acceptable additives selected from surfactant(s), carrier(s) and other additive(s) uniformly in a mixer, and optionally milling by a mill.

13. A method for the management of the undesired insect pests or mites or acarids, said method comprising applying to the insect pests or mites or unwanted acarids the combination of claim 1.

14. The combination as claimed in claim 1, wherein the ratio of flubendiamide and seaweed extract is from 1:50 to 50:1.

15. The combination as claimed in claim 1, wherein the ratio of flubendiamide and seaweed extract is from 1:20 to 20:1.

16. The combination as claimed in claim 1, wherein the particle size of the active ingredient(s) is in the range of 1 to 50 μm.

17. The combination as claimed in claim 1, wherein the particle size of the active ingredient(s) is in the range of 5 to 20 μm.

18. A method for the management of the undesired insect pests or mites or acarids, said method comprising applying to the insect pests or mites or unwanted acarids the composition of claim 8.
